(19) United States
(12) Patent Application Publication
(10) Pub. No.: US 2020/0270525 A1
(43) Pub. Date: Aug. 27, 2020

(54) LIQUID CRYSTAL COMPOSITION AND LIGHT SWITCHING DEVICE

(71) Applicants: JNC CORPORATION, Tokyo (JP); JNC PETROCHEMICAL CORPORATION, Tokyo (JP)

(72) Inventors: Yuki KOBARI, CHIBA (JP); Masayuki SAITO, CHIBA (JP)

(73) Assignees: JNC CORPORATION, Tokyo (JP); JNC PETROCHEMICAL CORPORATION, Tokyo (JP)

(21) Appl. No.: 16/654,025

(22) Filed: Oct. 16, 2019

(30) Foreign Application Priority Data
Feb. 22, 2019 (JP) 2019-030306

(51) Int. Cl. C09K 19/44; C09K 19/46; C09K 19/30; C09K 19/12; C09K 19/14; C09K 19/34

(52) U.S. Cl. CPC C09K 19/44; C09K 2019/3037; C09K 19/3003; C09K 19/12; C09K 19/3068; C09K 19/14; C09K 19/3402; C09K 19/3028; C09K 2019/3004; C09K 2019/3009; C09K 2019/122; C09K 2019/3071; C09K 2019/123; C09K 2019/3016; C09K 2019/3015; C09K 2019/3078; C09K 2019/3021; C09K 2019/3025; C09K 2019/301; C09K 2019/3077; C09K 2019/3425; C09K 2019/3083; C09K 2019/3019; C09K 2019/3036; C09K 19/46

(57) ABSTRACT

A liquid crystal composition that satisfies at least one of characteristics such as a high maximum temperature, a low minimum temperature, a wide temperature range of a liquid crystal phase, a small viscosity, a large optical anisotropy, a large positive or negative dielectric anisotropy, a large specific resistance, a high stability to light, a high stability to heat and a large elastic constant or that is suitably balanced between at least two of these characteristics. The means is use of a liquid crystal composition that includes a specific compound having a high maximum temperature or a small viscosity as a first component, and that may include a specific compound having a large positive dielectric anisotropy as a second component, or a specific compound having a large negative dielectric anisotropy as a third component or a specific compound having a polymerizable group as a first additive.

### CROSS-REFERENCE TO RELATED APPLICATION

This application claims the priority benefit of Japan application no. 2019-030306, filed on Feb. 22, 2019. The entirety of each of the above-mentioned patent applications is hereby incorporated by reference herein and made a part of this specification.

### BACKGROUND

### Technical Field

The disclosure relates to a liquid crystal composition, a light switching device including this composition, and so forth.

### Technical Background

The LIDAR (Laser Imaging Detection and Ranging) is one of remote sensing technologies using light. This is a method in which scattering light generated by leaser light irradiation is measured, and the distance to an objective located at a long distance or the properties of the objective is analyzed (Patent document No. 1). The LIDAR is utilized in the field of geology, aerography and so forth, and is focused in the area of automated driving because of a high accuracy of observation.

Paragraph 0027 in Patent document No. 1 (WO 2018-156643 A) describes “In an embodiment, the electrically-adjustable material is a liquid crystal material”, where an application of a liquid crystal material (that is to say, a liquid crystal composition) to a light switching device is suggested. The device is a device that turns on and off, or distributes light signals. The device corresponds to a switch in an electronic circuit, since it changes the route of light itself without changing the light signals to an electric signal. We thus have studied a liquid crystal composition suitable for a light switching device used for technologies such as the LIDAR.

### SUMMARY

The disclosure is use of a liquid crystal composition satisfying at least one of characteristics such as a high maximum temperature of a nematic phase, a low minimum temperature of a nematic phase, a wide temperature range of a liquid crystal phase, a small viscosity, a large optical anisotropy, a large positive or large negative dielectric anisotropy, a large specific resistance, a high stability to light, a high stability to heat and a large elastic constant. Also the disclosure is use of a liquid crystal composition having a suitable balance between at least two of these characteristics. Also the disclosure is use of a light switching device having such a composition. Also the disclosure is use of a light switching device having characteristics such as a short response time, a large voltage holding ratio, a low threshold voltage, a large contrast and a long service life.

The disclosure relates to use and so forth, of a liquid crystal composition including at least one compound selected from compounds represented by formula (1) as a first component, where the retardation is changed from 0 to λ/2 by a voltage change, for a light switching deice.

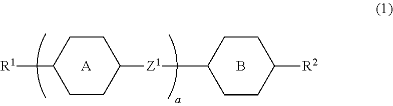

In formula (1), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine; ring A and ring B are 1,4-cyclohexylene, 1,4-phenylene, 2-fluoro-1,4-phenylene or 2,5-difluoro-1,4-phenylene; Z¹ is a single bond, ethylene, vinylene, methyleneoxy or carbonyloxy; and a is 1, 2 or 3

### DESCRIPTION OF THE EMBODIMENTS

The usage of the terms in the specification and claims is as follows. The terms “liquid crystal composition” and “liquid crystal display device” are sometimes abbreviated to “composition” and “device,” respectively. “Liquid crystal display device” is a generic term for a liquid crystal display panel and a liquid crystal display module. “Liquid crystal compound” is a generic term for a compound having a liquid crystal phase such as a nematic phase or a smectic phase, and for a compound having no liquid crystal phases but being mixed with a composition for the purpose of adjusting the characteristics, such as the temperature range of a nematic phase, the viscosity and the dielectric anisotropy. This compound has a six-membered ring such as 1,4-cyclohexylene or 1,4-phenylene, and its molecules (liquid crystal molecules) is rod-like. “Polymerizable compound” is a compound that is added to a composition in order to form a polymer in it. A liquid crystal compound having alkenyl is not classified into the polymerizable compound in that sense.

“Liquid crystal composition” is prepared by mixing a plurality of liquid crystal compounds. An additive such as an optically active compound or a polymerizable compound is added to this liquid crystal composition as required. Even if the additive is added, the ratio of a liquid crystal compound is expressed as a percentage by mass (% by mass) based on the liquid crystal composition excluding the additive. The ratio of the additive is expressed as a percentage by mass (% by mass) based on the liquid crystal composition excluding the additive. That is to say, the ratio of the additive or the liquid crystal compound is calculated on the basis of the total amount of the liquid crystal compounds. The ratio of the polymerization initiator and the polymerization inhibitor is expressed on the basis of the total amount of the polymerizable compounds. Incidentally, “% by mass” is sometimes abbreviated as “%”.

“The maximum temperature of a nematic phase” is sometimes abbreviated to “the maximum temperature”. “The minimum temperature of a nematic phase” is sometimes abbreviated to “the minimum temperature”. The expression “increase the dielectric anisotropy” means that its value increases positively when the composition has positive dielectric anisotropy, and that its value increases negatively when the composition has negative dielectric anisotropy. That “voltage holding ratio is large” means that a device has a large voltage holding ratio at a temperature close to the maximum temperature as well as at room temperature in the initial stages, and that the device has a large voltage holding ratio at a temperature close to the maximum temperature as well as at room temperature, after it has been used for a long time. The characteristics of compositions or devices are sometimes studied by means of a long-term test.

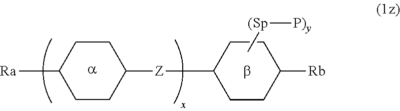

Compound (1z) described above is explained as an example. In formula (1z), the symbols α and β surrounded by a hexagon correspond to ring α and ring β, respectively, and represent a ring such as a six-membered ring or a condensed ring. Two rings α are present when the subscript ‘x’ is 2. Two groups represented by two rings a may be the same or different. The rule applies to arbitrary two rings α, when the subscript ‘x’ is greater than 2. The rule applies to other symbols such as bonding group Z. An oblique line that intersects one side of the hexagon means that arbitrary hydrogen on the ring β may be replaced by substituent (—Sp—P). The subscript ‘y’ shows the number of the substituent that has been replaced. There is no replacement when subscript ‘y’ is 0 (zero). A plurality of substituents (—Sp—P) is present on ring β when subscript ‘y’ is 2 or more. In this case, the rule “may be the same or different” is also applied. Incidentally, the rule applies to the symbol Ra that is used for a plurality of compounds.

In formula (1z), an expression such as “Ra and Rb are alkyl, alkoxy, or alkenyl” means that Ra and Rb are independently selected from the group of alkyl, alkoxy and alkenyl, where a group represented by Ra and a group represented by Rb may be the same or different.

At least one compound selected from compounds represented by formula (1z) is sometimes abbreviated to “compound (1z)”. “Compound (1z)” means one compound, a mixture of two compounds or a mixture of three or more compounds represented by formula (1z). This applies to a compound represented by another formula. The expression “at least one compound selected from compounds represented by formula (1z) and formula (2z)” means that at least one compound selected from the group of compound (1z) and compound (2z).

The expression “at least one ‘A’” means that the number of ‘A’ is arbitrary. The expression “at least one ‘A’ may be replaced by ‘B’” means that the position of ‘A’ is arbitrary when the number of ‘A’ is one, and when the number of ‘A’ is two or more, these positions can also be selected without restriction. The expression “at least one —CH₂— may be replaced by —O—” is sometimes used. In this case, —CH₂—CH₂—CH₂— may be transformed to —O—CH₂—O— by replacement of nonadjacent —CH₂— with —O—. However, adjacent —CH₂— should not be replaced by —O—. This is because of the formation of —O—O—CH₂— (peroxide) by this replacement.

Alkyl in a liquid crystal compound is straight or branched, and does not include cycloalkyl. Straight alkyl is preferable to branched alkyl. This applies to a terminal group such as alkoxy and alkenyl. With regard to the configuration of 1,4-cyclohexylene, trans is preferable to cis for increasing the maximum temperature. 2-Fluoro-1,4-phenylene is asymmetric so that facing left (L) and facing right (R) are present.

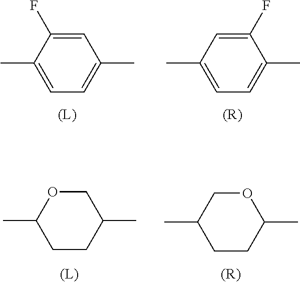

The same applies to a divalent group such as tetrahydropyran-2,5-diyl. The same applies to a bonding group such as carbonyloxy (—COO— or —OCO—).

The disclosure includes the following items.

Item 1. Use of a liquid crystal composition including at least one compound selected from compounds represented by formula (1) as a first component, for a light switching deice where the retardation is changed from 0 to 212 by a voltage change:

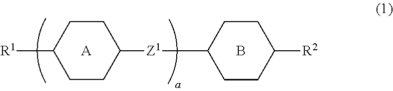

in formula (1), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine; ring A and ring B are 1,4-cyclohexylene, 1,4-phenylene, 2-fluoro-1,4-phenylene or 2,5-difluoro-1,4-phenylene; Z¹ is a single bond, ethylene, vinylene, methyleneoxy or carbonyloxy; and a is 1, 2 or 3.
Item 2. Use for the light switching device according to item 1, of a liquid crystal composition including at least one compound selected from compounds represented by formula (1-1) to formula (1-13) as a first component:

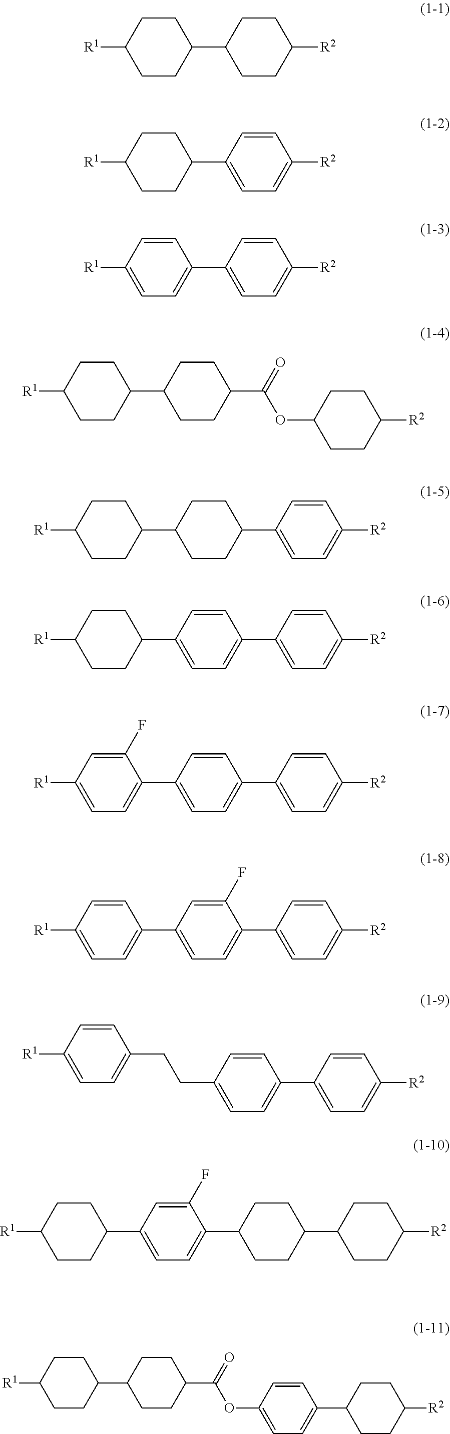

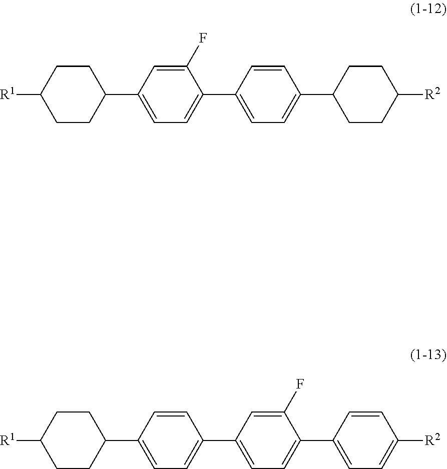

in formula (1-1) to formula (1-13), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine.
Item 3. Use for the light switching device according to item 1 or 2, of a liquid crystal composition in which the ratio of the first component is in the range of 10% to 90%.
Item 4. Use for the light switching device according to any one of items 1 to 3, of a liquid crystal composition including at least one compound selected from compounds represented by formula (2) as a second component:

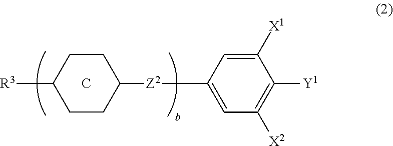

in formula (2), R³ is alkyl having 1 to 12 carbons, alkoxy having 1 to 12 carbons or alkenyl having 2 to 12 carbons; ring C is 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl or tetrahydropyran-2,5-diyl; Z² is a single bond, ethylene, vinylene, methyleneoxy, carbonyloxy or difluoromethyleneoxy; X¹ and X² are hydrogen or fluorine; Y¹ is fluorine, chlorine, alkyl having 1 to 12 carbons in which at least one hydrogen has been replaced by fluorine or chlorine, alkoxy having 1 to 12 carbons in which at least one hydrogen has been replaced by fluorine or chlorine or alkenyloxy having 2 to 12 carbons in which at least one hydrogen has been replaced by fluorine or chlorine; and b is 1, 2, 3 or 4.
Item 5. Use for the light switching device according to any one of items 1 to 4, of a liquid crystal composition including at least one compound selected from compounds represented by formula (2-1) to formula (2-35) as a second component:

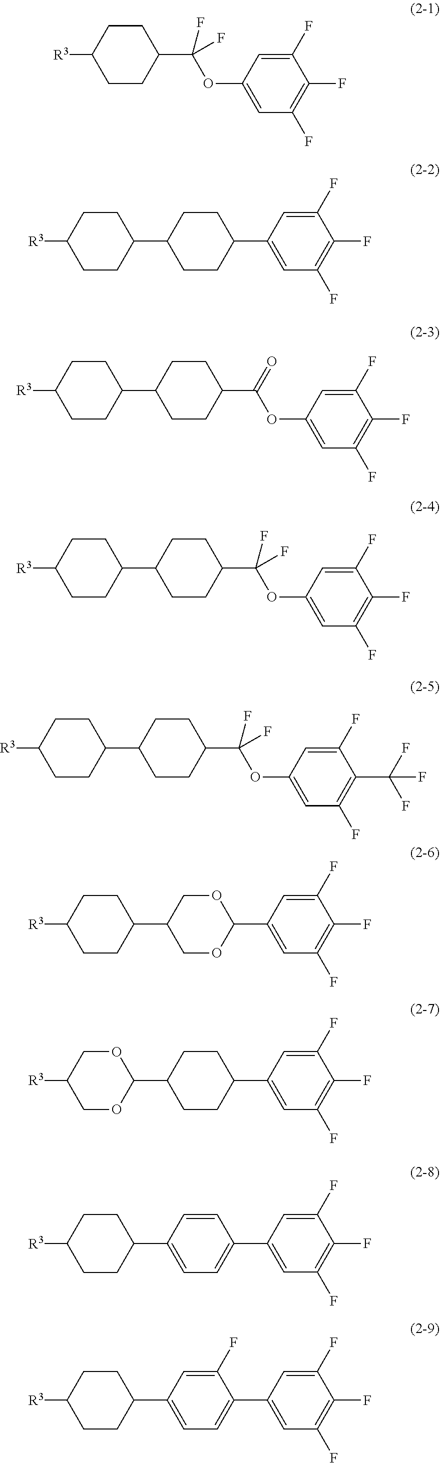

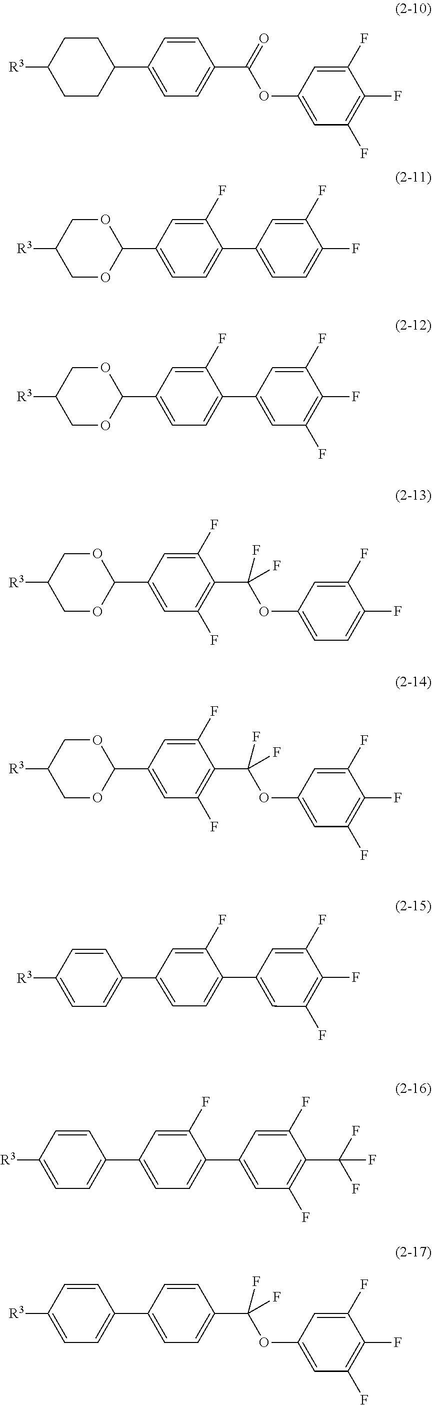

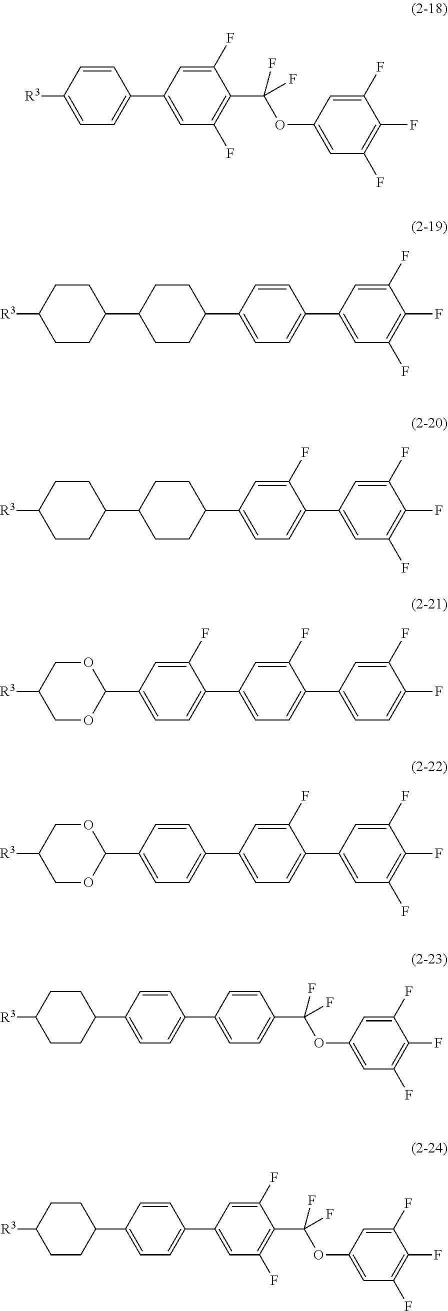

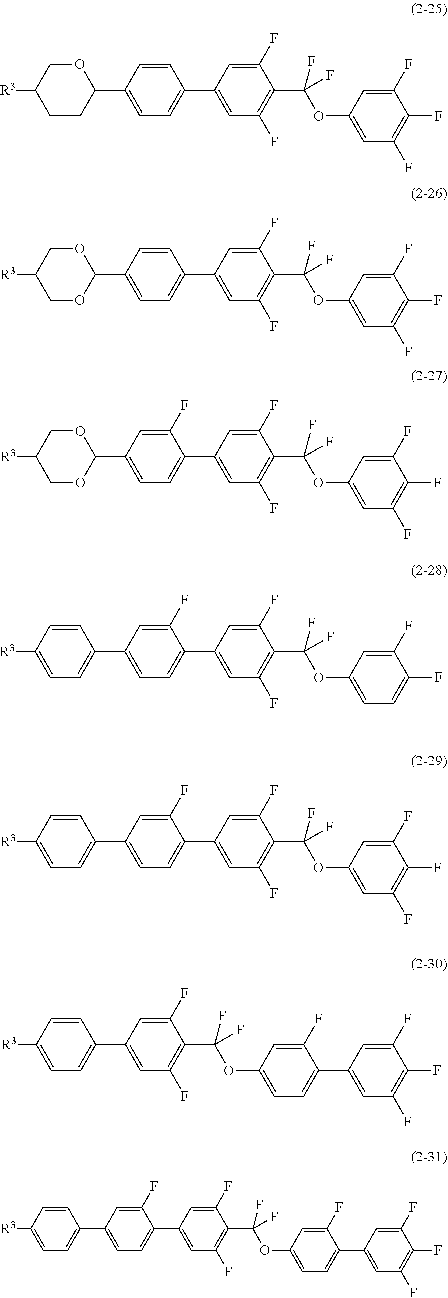

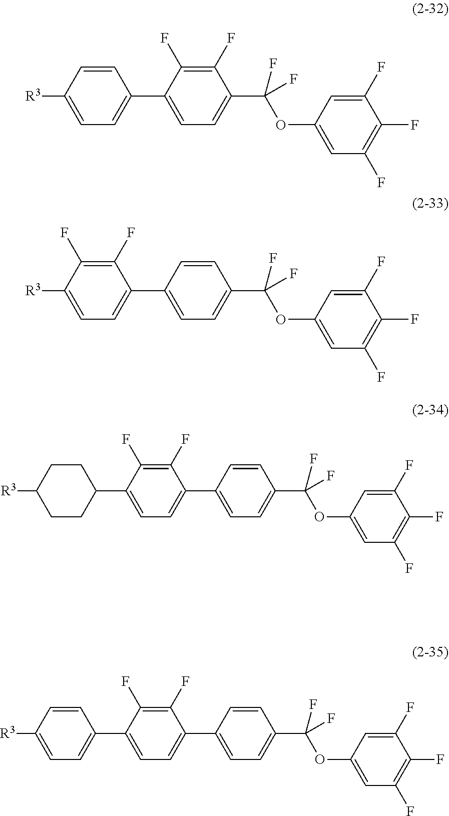

in formula (2-1) to formula (2-35), R³ is alkyl having 1 to 12 carbons, alkoxy having 1 to 12 carbons or alkenyl having 2 to 12 carbons.
Item 6. Use for the light switching device according to item 4 or 5, of a liquid crystal composition in which the ratio of the second component is in the range of 10% to 90%.
Item 7. Use for the light switching device according to any one of items 1 to 6, of a liquid crystal composition including at least one compound selected from compounds represented by formula (3) as a third component:

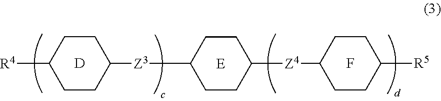

in formula (3), R⁴ and R⁵ are hydrogen, alkyl having 1 to 12 carbons, alkoxy having 1 to 12 carbons, alkenyl having 2 to 12 carbons or alkenyloxy having 2 to 12 carbons; ring D and ring F are 1,4-cyclohexylene, 1,4-cyclohexenylene, tetrahydropyran-2,5-diyl, 1,4-phenylene, 1,4-phenylene in which at least one hydrogen has been replaced by fluorine or chlorine, naphthalene-2,6-diyl, naphthalene-2,6-diyl in which at least one hydrogen has been replaced by fluorine or chlorine, chromane-2,6-diyl or chromane-2,6-diyl in which at least one hydrogen has been replaced by fluorine or chlorine; ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, 7,8-difluorochromane-2,6-diyl, 3,4,5,6-tetrafluorofluorene-2,7-diyl, 4,6-difluorodibenzofuran-3,7-diyl, 4,6-difluorodibenzothiophene-3,7-diyl or 1,1,6,7-tetrafluoroindane-2,5-diyl; Z³ and Z⁴ are a single bond, ethylene, vinylene, methyleneoxy or carbonyloxy; and c is 0, 1, 2 or 3, d is 0 or 1, and the sum of c and d is 3 or less.
Item 8. Use for the light switching device according to any one of items 1 to 7, of a liquid crystal composition including at least one compound selected from compounds represented by formula (3-1) to formula (3-35) as a third component:

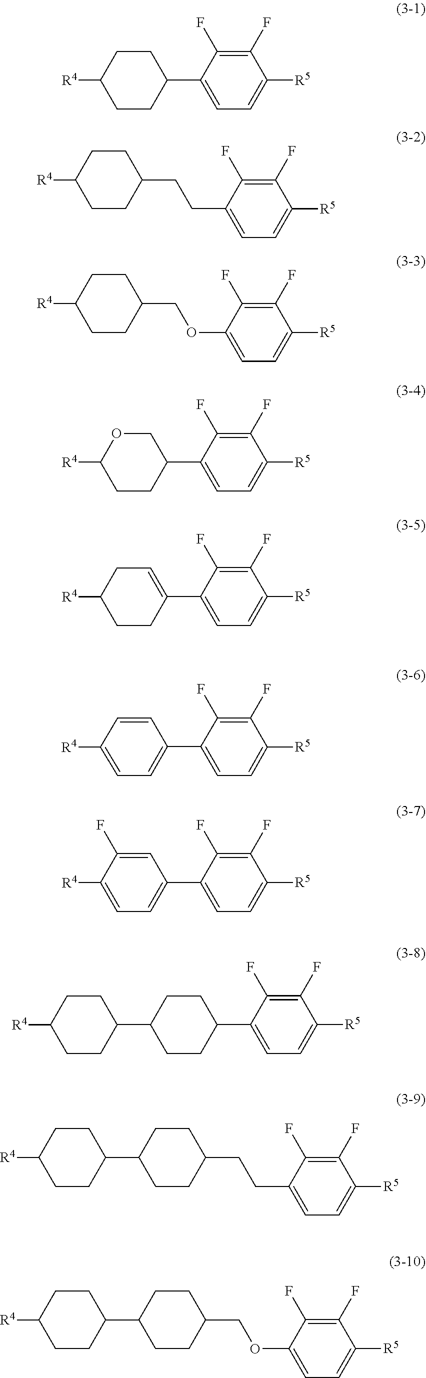

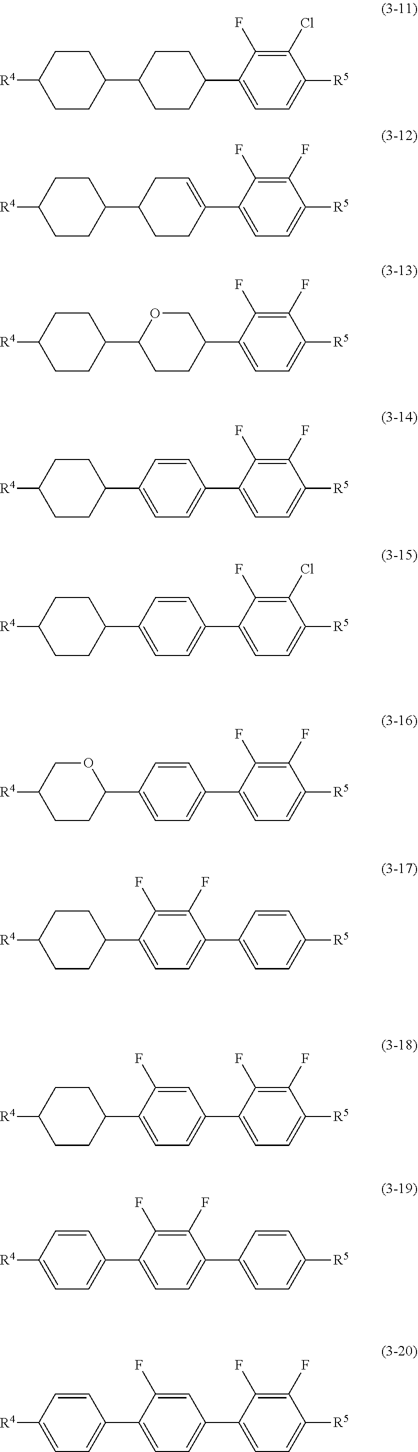

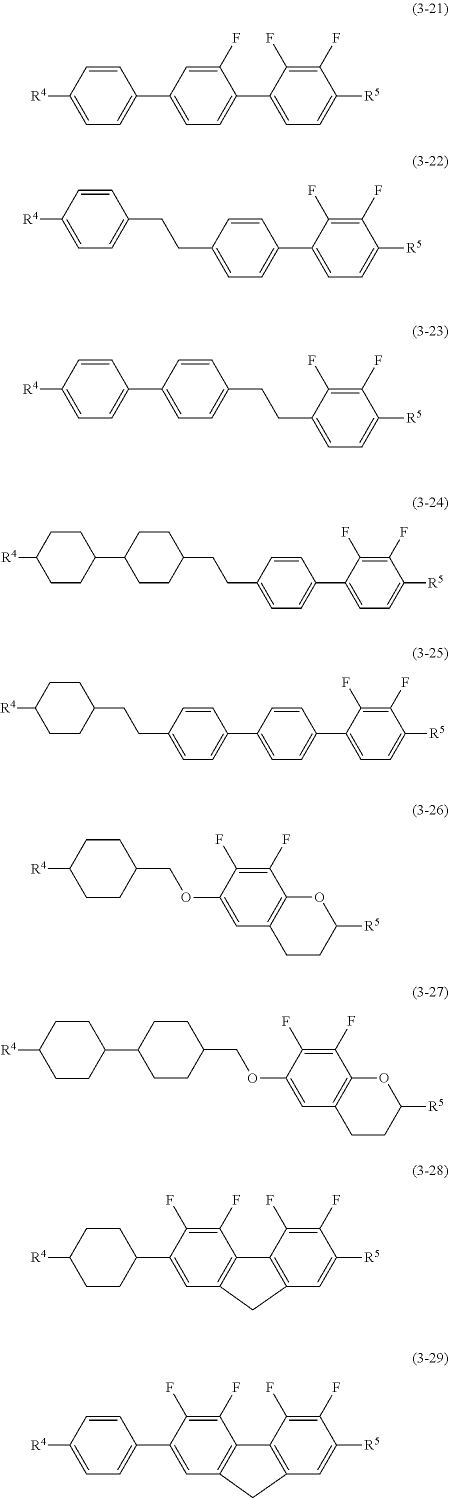

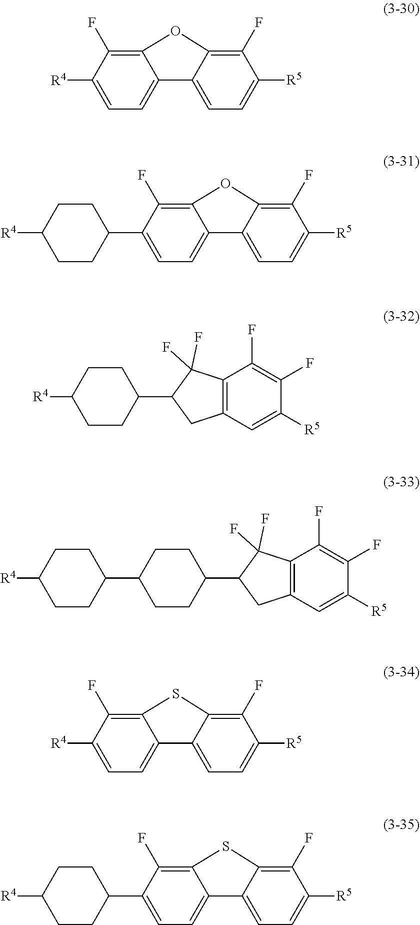

in formula (3-1) to formula (3-35), R⁴ and R⁵ are hydrogen, alkyl having 1 to 12 carbons, alkoxy having 1 to 12 carbons, alkenyl having 2 to 12 carbons or alkenyloxy having 2 to 12 carbons.
Item 9. Use for the light switching device according to item 7 or 8, of a liquid crystal composition in which the ratio of the third component is in the range of 10% to 90%.
Item 10. Use for the light switching device according to any one of items 1 to 9, of a liquid crystal composition including at least one compound selected from polymerizable compounds represented by formula (4) as a first additive:

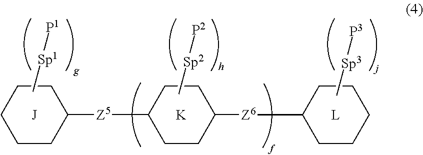

in formula (4), ring J and ring L are cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine; ring K is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine; Z⁵ and Z⁶ are a single bond or alkylene having 1 to 10 carbons, and in the alkylene at least one —CH₂— may be replaced by —O—, —CO—, —COO— or —OCO—, at least one —CH₂CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine; P¹, P² and P³ are a polymerizable group; Sp¹, Sp² and Sp³ are a single bond or alkylene having 1 to 10 carbons, and in the alkylene at least one —CH₂— may be replaced by —O—, —COO—, —OCO— or —OCOO—, at least one —CH₂CH₂— may be replaced by —CH═CH— or —C≡C—, and in these groups at least one hydrogen may be replaced by fluorine or chlorine; f is 0, 1 or 2; g, h and j are 0, 1, 2, 3 or 4; and the sum of g, h and j is 1 or more.
Item 11. Use for the light switching device according item 10, of a liquid crystal composition including at least one compound where in formula (4) P¹, P² and P³ are a group selected from polymerizable groups represented by formula (P-1) to formula (P-5):

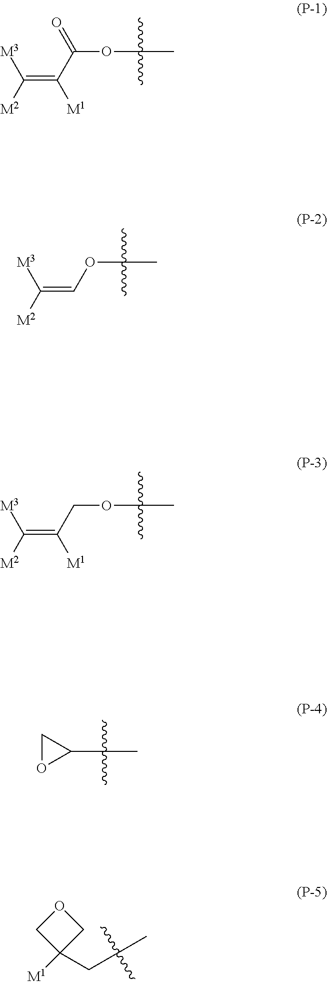

in (P-1) to formula (P-5), M¹, M² and M³ are hydrogen, fluorine, alkyl having 1 to 5 carbons or alkyl having 1 to 5 carbons in which at least one hydrogen has been replaced by fluorine or chlorine.
Item 12. Use for the light switching device according to any one of items 1 to 11, of a liquid crystal composition including at least one compound selected from polymerizable compounds represented by formula (4-1) to formula (4-29) as a first additive:

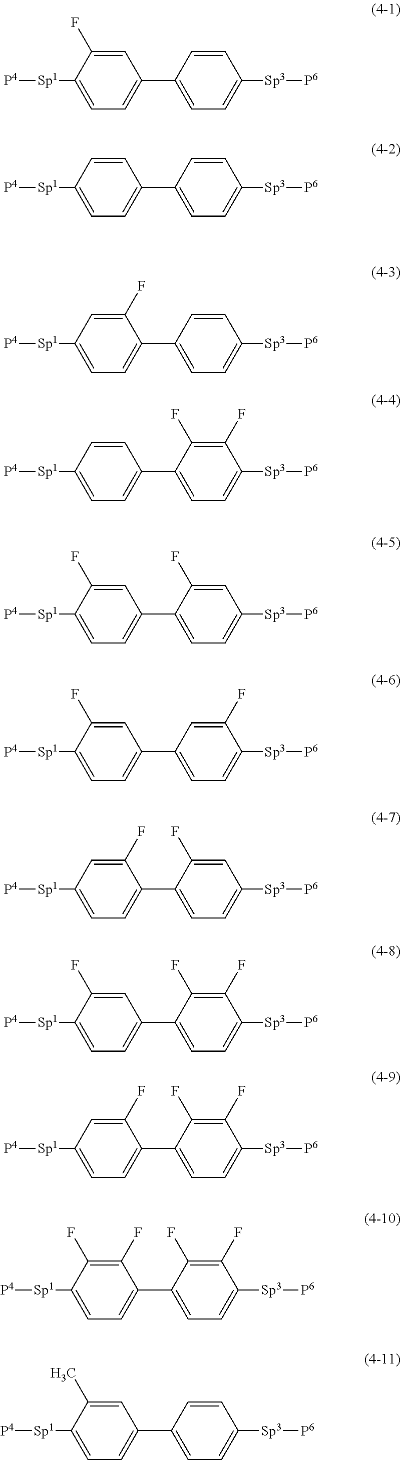

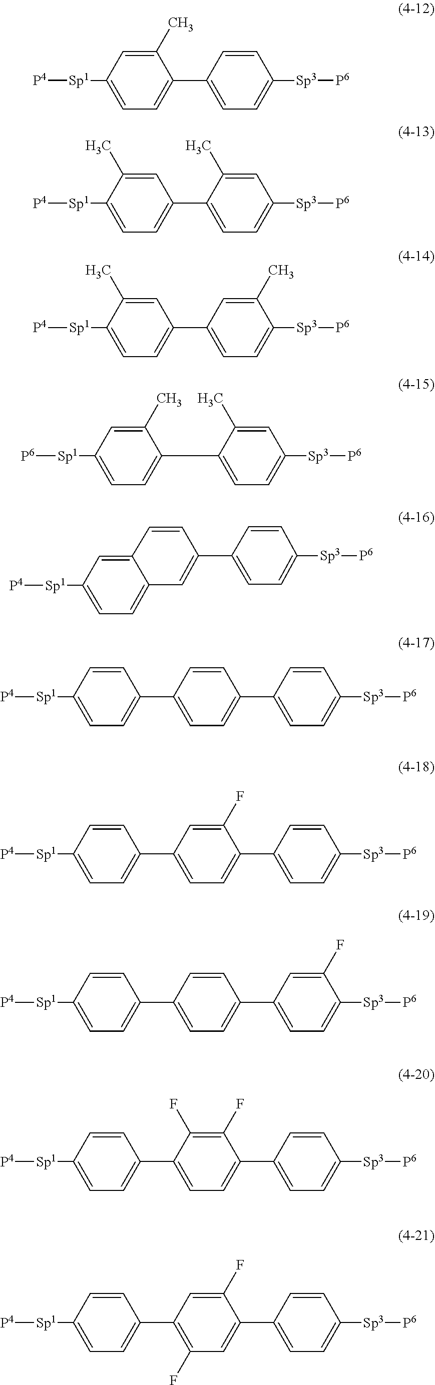

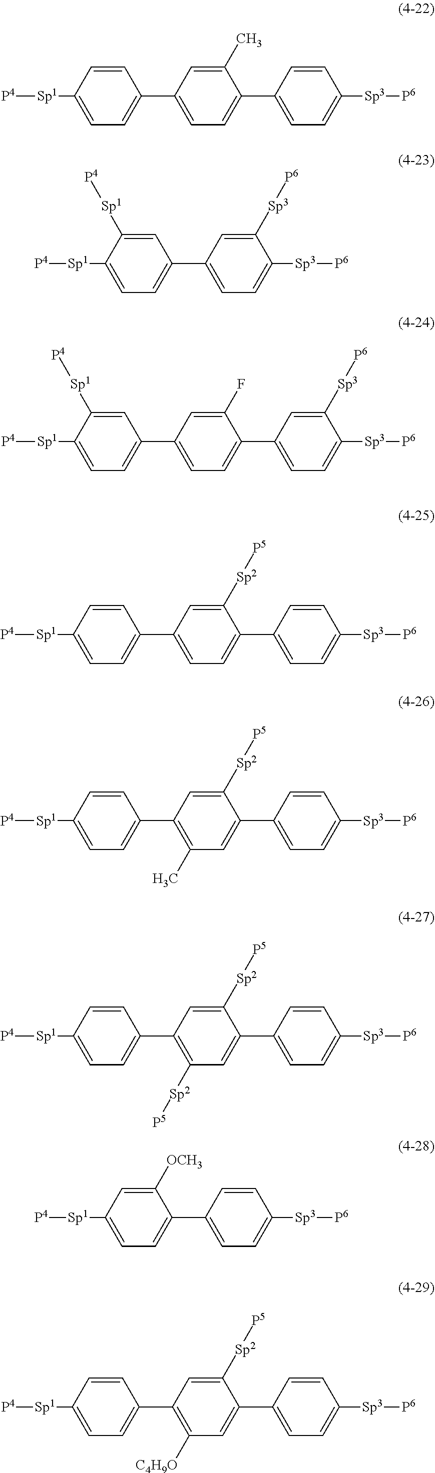

in formula (4-1) to formula (4-29), Sp¹, Sp² and Sp³ are a single bond or alkylene having 1 to 10 carbons, and in the alkylene at least one —CH₂— may be replaced by —O—, —COO—, —OCO— or —OCOO—, at least one —CH₂CH₂— may be replaced by —CH═CH— or —C≡C—, and in these groups at least one hydrogen may be replaced by fluorine or chlorine; and P⁴, P⁵ and P⁶ are a polymerizable group selected from groups of formula (P-1) to formula (P-3):

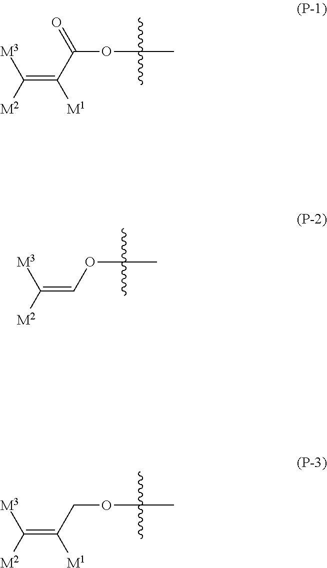

in formula (P-1) to formula (P-3), M¹, M² and M³ are hydrogen, fluorine, alkyl having 1 to 5 carbons or alkyl having 1 to 5 carbons in which at least one hydrogen has been replaced by fluorine or chlorine.
Item 13. Use for the light switching device according to any one of items 10 to 12, of a liquid crystal composition in which the ratio of the first additive is in the range of 0.03% to 10%.
Item 14. Use for the light switching device according to any one of items 1 to 13, of a liquid crystal composition in which the maximum temperature of a nematic phase is 70° C. or higher, the optical anisotropy (measured at 25° C.) at a wavelength of 589 nanometers is 0.07 or more, and the dielectric anisotropy (measured at 25° C.) at a frequency of 1 kHz is 2 or more or −2 or less.
Item 15. A liquid crystal composition described according to any one of items 1 to 14, for a light switching device.
Item 16. A light switching device having two substrates, wherein at least one of the two substrates has a meta-surface, and the two substrates have the liquid crystal composition according to any one of items 1 to 14 between these two.
Item 17. Use of the liquid crystal composition according to any one of items 1 to 14, for a LIDAR technology.

The disclosure includes also the following items. (a) Use of the liquid crystal composition described above, including at least one of an optically active compound, an antioxidant, an ultraviolet light absorber, a quencher, a coloring matter, an antifoaming agent, a polymerization initiator and a polymerization inhibitor as a second additive, for a light switching device. (b) Use of the liquid crystal composition described above, including a polymerizable compound that is different from the polymerizable compound described above, for a light switching device.

The disclosure includes also the following items. (c) Use of a composition including compound (1-1) according to item 2 as a main component in the first component, for the light switching device described above. Incidentally, the main component means a component that accounts for the greatest proportion of a mixture. For example, in a mixture of 40% of compound (I), 30% of compound (II) and 30% of compound (III), the main component is compound (I). When the component of a mixture is compound (I) alone, compound (I) is also referred to as a main component. (d) Use of a composition where the optical anisotropy is 0.25 or more, for the light switching device described above.

The disclosure includes also the following items. (e) A light switching device having the composition described above, including one compound, two compounds or three or more compounds selected from additives such as an optically active compound, an antioxidant, an ultraviolet light absorber, a quencher, a coloring matter, an antifoaming agent, a polymerizable compound, a polymerization initiator and a polymerization inhibitor. (f) A light switching device having the composition described above, including a polymerizable compound that is different from compound (4). (g) A light switching device having the composition described above, wherein a polymerizable compound in the composition has been polymerized. (h) Use of the device having the composition described above as a light switching device. (i) Use of the composition described above as a composition having a nematic phase for a light switching device.

The disclosure includes also the following items. (j) Use of the composition described above as a composition having a chiral nematic phase, for a light switching device. (k) Use of the composition described above as a composition having a smectic A phase or a smectic C phase, for a light switching device. (l) Use of the composition described above as a composition having a chiral smectic C phase, for a light switching device. (m) Use of the composition described above as a composition having a chiral smectic C_{A} phase, for a light switching device. (n) A light switching device, wherein one of two substrates has a meta-surface, and the two substrates have a liquid crystal composition described above between these two. (o) Use of the light switching device described above, for a LIDAR technology.

The light switching device used in the disclosure is explained.

A polarizing plate is a device that passes light only polarized light in a specific direction. When light is passed through a wire grid polarizer, it is converted to linearly polarized light. In contrast, a wave plate is a device that changes the polarization state of light when light passes through it. A half-wave plate gives retardation (212) to incident linearly polarized light. Horizontal linearly polarized light is changed to vertical linearly polarized light. The half-wave plate can also change the rotational direction of circularly polarized light in the opposite direction. A quarter-wave plate changes linearly polarized light to circularly polarized light, and vice versa. Herein, a light switching device utilizing characteristics of liquid crystals is used instead of the wave plate.

The light switching device has a structure in which a liquid crystal composition is sandwiched between two glass substrates having an electrode. The composition has optical anisotropy so that retardation (phase difference) occurs when light passes through the device. When the composition has optical anisotropy (Δn), and the distance of substrates is d, retardation is defined as Δn×d. The optical anisotropy has voltage-dependence. Then, the retardation can be adjusted by changing a voltage applied to the device. Thus, the device has a function of a wave plate, in addition to a function that turns on and off light signals.

The range of light wavelengths suitable for the light switching device is wide. Desirable light is visible light (0.38 to 0.78 micrometers), near infrared light (0.72 to 2.5 micrometers) or millimeter waves (1 to 10 mm). When the device is irradiated with such light, the retardation is changed in the range 0 to λ/2 by a voltage change. The retardation is changed within at least this range.

In the light switching device, one of two glass substrates may be replaced by a substrate having a meta-surface. See Paragraph 0069 in Patent document No. 2 (WO 2018-156688 A). A meta-surface is an artificial surface having a reflection characteristic that does not exist in nature. Incident light is reflected by the meta-surface. The angle of reflected light can be adjusted by changing a voltage applied to the device. This is because the optical anisotropy of the liquid crystal composition has voltage dependence.

The composition used in the disclosure will be explained in the following order: First, the structure of the composition will be explained. Second, the main characteristics of the component compounds and the main effects of these compounds on the composition or the device will be explained. Third, a combination of the component compounds in the composition, a desirable ratio and its basis will be explained. Fourth, a desirable embodiment of the component compounds will be explained. Fifth, desirable component compounds will be shown. Sixth, additives that may be added to the composition will be explained. Seventh, methods for synthesizing the component compounds will be explained. Last, the use of the composition will be explained.

First, the structure of the composition will be explained. The composition includes a plurality of liquid crystal compounds. The composition may include an additive. The additive includes an optically active compound, an antioxidant, an ultraviolet light absorber, a quencher a coloring matter, an antifoaming agent, a polymerizable compound, a polymerization initiator, a polymerization inhibitor and a polar compound. The compositions are classified into composition A and composition B in view of liquid crystal compounds. Composition A may further include any other liquid crystal compound, an additive and so forth, in addition to liquid crystal compounds selected from compound (1), compound (2) and compound (3). “Any other liquid crystal compound” is a liquid crystal compound that is different from compound (1), compound (2) and compound (3). Such a compound is mixed with the composition for the purpose of further adjusting the characteristics.

Composition B consists essentially of liquid crystal compounds selected from compound (1), compound (2) and compound (3). The term “essentially” means that the composition B may include an additive, however it does not include any other liquid crystal compound. Composition B has a smaller number of components than composition A. Composition B is preferable to composition A in view of cost reduction. Composition A is preferable to composition B in view of the fact that characteristics can be further adjusted by mixing with any other liquid crystal compound.

Second, the main characteristics of the component compounds and the main effects of these compounds on the composition or the device will be explained. Table 2 summarizes the main characteristics of the component compounds. In Table 2, the symbol L stands for “large” or “high”, the symbol M stands for “medium”, and the symbol S stands for “small” or “low”. The symbols L, M and S mean a classification based on a qualitative comparison among the component compounds, and the symbol 0 (zero) means smaller than S.

TABLE 2
Characteristics of liquid crystal compounds

| | Compound | Compound | Compound |
|---|---|---|---|
| Compounds | (1) | (2) | (3) |
| Maximum Temperature | S-L | S-L | S-M |
| Viscosity | S-M | M-L | M |
| Optical Anisotropy | S-L | M-L | M-L |
| Dielectric Anisotropy | 0 | S-L¹⁾ | M-L²⁾ |
| Specific Resistance | L | L | L |

¹⁾The value of the dielectric anisotropy is positive, and the symbol expresses the magnitude of the absolute value.
²⁾The value of the dielectric anisotropy is negative, and the symbol expresses the magnitude of the absolute value.

The main effects of the component compounds are as follows. Compound (1) decreases the viscosity or increases the maximum temperature. Compound (2) increases positive dielectric anisotropy. Compound (3) increases negative dielectric anisotropy. Compound (4) is polymerizable and thus gives a polymer by polymerization. The polymer decreases the response time of the device, since it stabilizes the alignment of liquid crystal molecules.

Third, a combination of the component compounds in the composition, a desirable ratio and its basis will be explained. The composition having positive dielectric anisotropy is prepared by mixing compound (1) with compound (2). A small amount of compound (3) may be added to the composition for the purpose of adjusting the elastic constant of the composition or adjusting a voltage-transmission curve. In contrast, the composition having negative dielectric anisotropy is prepared by mixing compound (1) with compound (3). A small amount of compound (2) may be added to the composition for the purpose of adjusting the elastic constant of the composition or adjusting a voltage-transmission curve. Any other liquid crystal compound may be added to these composition as required.

A desirable ratio of compound (1) is approximately 10% or more for increasing the maximum temperature or for decreasing the viscosity, and is approximately 90% or less for increasing the dielectric anisotropy. A more desirable ratio is in the range of approximately 20% to approximately 80%. An especially desirable ratio is in the range of approximately 30% to approximately 70%.

A desirable ratio of compound (2) is approximately 10% or more for increasing positive dielectric anisotropy, and is approximately 90% or less for decreasing the minimum temperature. A more desirable ratio is in the range of approximately 20% to approximately 80%. An especially desirable ratio is in the range of approximately 30% to approximately 70%.

A desirable ratio of compound (3) is approximately 10% or more for increasing negative dielectric anisotropy, and is approximately 90% or less for decreasing the minimum temperature. A more desirable ratio is in the range of approximately 20% to approximately 80%. An especially desirable ratio is in the range of approximately 30% to approximately 70%.

Compound (4) is added to the composition for the purpose of adjusting to a device with a polymer sustained alignment (PSA) type. A desirable ratio of compound (4) is approximately 0.03% or more for aligning liquid crystal molecules, and is approximately 10% or less for preventing display defects of a device. A more desirable ratio is in the range of approximately 0.1% to approximately 2%. An especially desirable ratio is in the range of approximately 0.2% to approximately 1%.

Fourth, a desirable embodiment of the component compounds will be explained. In formula (1), formula (2) and formula (3), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine. Desirable R¹ or R² is alkenyl having 2 to 12 carbons for decreasing the viscosity, or is alkyl having 1 to 12 carbons for increasing the stability to light or heat. R³ is alkyl having 1 to 12 carbons, alkoxy having 1 to 12 carbons or alkenyl having 2 to 12 carbons. Desirable R³ is alkyl having 1 to 12 carbons for increasing the stability to light or heat. R⁴ and R⁵ are hydrogen, alkyl having 1 to 12 carbons, alkoxy having 1 to 12 carbons, alkenyl having 2 to 12 carbons or alkenyloxy having 2 to 12 carbons. Desirable R⁴ or R⁵ is alkyl having 1 to 12 carbons for increasing the stability to light or heat, and is alkoxy having 1 to 12 carbons for increasing the dielectric anisotropy.

Desirable alkyl is methyl, ethyl, propyl, butyl, pentyl, hexyl, heptyl or octyl. More desirable alkyl is methyl, ethyl, propyl, butyl and pentyl for decreasing the viscosity.

Desirable alkoxy is methoxy, ethoxy, propoxy, butoxy, pentyloxy, hexyloxy or heptyloxy. More desirable alkoxy is methoxy or ethoxy for decreasing the viscosity.

Desirable alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. More desirable alkenyl is vinyl, 1-propenyl, 3-butenyl or 3-pentenyl for decreasing the viscosity. A desirable configuration of —CH═CH— in the alkenyl depends on the position of the double bond. Trans is preferable in the alkenyl such as 1-propenyl, 1-butenyl, 1-pentenyl, 1-hexenyl, 3-pentenyl and 3-hexenyl for decreasing the viscosity, for instance. Cis is preferable in the alkenyl such as 2-butenyl, 2-pentenyl and 2-hexenyl.

Desirable alkenyloxy is vinyloxy, allyloxy, 3-butenyloxy, 3-pentenyloxy or 4-pentenyloxy. More desirable alkenyloxy is allyloxy or 3-butenyloxy for decreasing the viscosity.

Desirable examples of alkyl in which at least one hydrogen has been replaced by fluorine or chlorine are fluoromethyl, 2-fluoroethyl, 3-fluoropropyl, 4-fluorobutyl, 5-fluoropentyl, 6-fluorohexyl, 7-fluoroheptyl or 8-fluorooctyl. More desirable examples are 2-fluoroethyl, 3-fluoropropyl, 4-fluorobutyl or 5-fluoropentyl for increasing the dielectric anisotropy.

Desirable examples of alkenyl in which at least one hydrogen has been replaced by fluorine or chlorine are 2,2-difluorovinyl, 3,3-difluoro-2-propenyl, 4,4-difluoro-3-butenyl, 5,5-difluoro-4-pentenyl or 6,6-difluoro-5-hexenyl. More desirable examples are 2,2-difluorovinyl or 4,4-difluoro-3-butenyl for decreasing the viscosity.

Ring A and ring B are 1,4-cyclohexylene, 1,4-phenylene, 2-fluoro-1,4-phenylene or 2,5-difluoro-1,4-phenylene. Desirable ring A or ring B is 1,4-cyclohexylene for decreasing the viscosity or for increasing the maximum temperature, and is 1,4-phenylene for decreasing the minimum temperature.

Ring C is 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl or tetrahydropyran-2,5-diyl. Desirable ring C is 1,4-cyclohexylene for increasing the maximum temperature, and is 1,4-phenylene for increasing the optical anisotropy, and is 2,6-difluoro-1,4-phenylene for increasing the dielectric anisotropy. Tetrahydropyran-2,5-diyl in ring C is

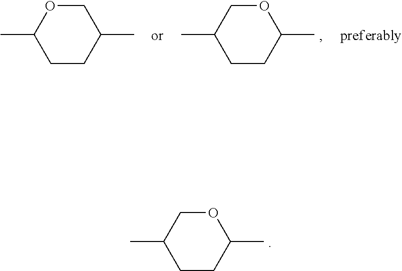

Ring D and ring F are 1,4-cyclohexylene, 1,4-cyclohexenylene, tetrahydropyran-2,5-diyl, 1,4-phenylene, 1,4-phenylene in which at least one hydrogen has been replaced by fluorine or chlorine, naphthalene-2,6-diyl, naphthalene-2,6-diyl in which at least one hydrogen has been replaced by fluorine or chlorine, chromane-2,6-diyl or chromane-2,6-diyl in which at least one hydrogen has been replaced by fluorine or chlorine. A desirable example of “1,4-phenylene in which at least one hydrogen has been replaced by fluorine or chlorine” is 2-fluoro-1,4-phenylene, 2,3-difluoro-1,4-phenylene or 2-chloro-3-fluoro-1,4-phenylene. Desirable ring D or ring F is 1,4-cyclohexylene for decreasing the viscosity, and is tetrahydropyran-2,5-diyl for increasing the dielectric anisotropy, and is 1,4-phenylene for increasing the optical anisotropy. Tetrahydropyran-2,5-diyl in ring D and ring F is preferably

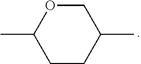

Ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, 7,8-difluorochromane-2,6-diyl, 3,4,5,6-tetrafluorofluorene-2,7-diyl (FLF4), 4,6-difluorodibenzofuran-3,7-diyl (DBFF2), 4,6-difluorodibenzothiophene-3,7-diyl (DBTF2) or 1,1,6,7-tetrafluoroindane-2,5-diyl (InF4).

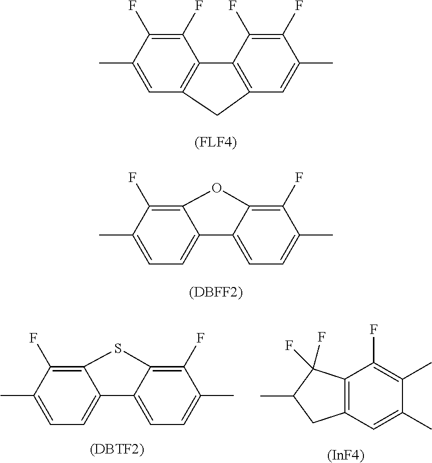

Desirable ring E is 2,3-difluoro-1,4-phenylene for decreasing the viscosity, and is 2-chloro-3-fluoro-1,4-phenylene for deceasing the optical anisotropy, and is 4,6-difluorodibenzothiophene-3,7-diyl for increasing the dielectric anisotropy.

Z¹ is a single bond, ethylene, vinylene, methyleneoxy or carbonyloxy. Desirable Z¹ is a single bond for decreasing the viscosity. Z² is a single bond, ethylene, vinylene, methyleneoxy, carbonyloxy or difluoromethyleneoxy. Desirable Z² is a single bond for decreasing the viscosity, and is difluoromethyleneoxy for increasing positive dielectric anisotropy. Z³ and Z⁴ are a single bond, ethylene, vinylene, methyleneoxy or carbonyloxy. Desirable Z³ or Z⁴ is a single bond for decreasing the viscosity, and is ethylene for decreasing the minimum temperature, and is methyleneoxy for increasing negative dielectric anisotropy.

A divalent group such as methyleneoxy is left-right asymmetric. In the methyleneoxy, —CH₂O— is preferable to —OCH₂—. In the carbonyloxy, —COO— is preferable to —OCO—. In the difluoromethyleneoxy, −CF₂O— is preferable to —OCF₂—.

X¹ and X² are hydrogen or fluorine. Desirable X¹ or X² is fluorine for increasing positive dielectric anisotropy.

Y¹ is fluorine, chlorine, alkyl having 1 to 12 carbons in which at least one hydrogen has been replaced by fluorine or chlorine, alkoxy having 1 to 12 carbons in which at least one hydrogen has been replaced by fluorine or chlorine or alkenyloxy having 2 to 12 carbons in which at least one hydrogen has been replaced by fluorine or chlorine. Desirable Y¹ is fluorine for decreasing the minimum temperature. A desirable example of alkyl in which at least one hydrogen has been replaced by fluorine or chlorine is trifluoromethyl. A desirable example of alkenyloxy in which at least one hydrogen has been replaced by fluorine or chlorine is trifluorovinyloxy.

a is 1, 2 or 3. Desirable a is 1 for decreasing the viscosity, and is 2 or 3 for increasing the maximum temperature. b is 1, 2, 3 or 4. Desirable b is 2 or 3 for increasing positive dielectric anisotropy. c is 0, 1, 2 or 3, d is 0 or 1, and the sum of c and d is 3 or less. Desirable c is 1 for decreasing the viscosity, and is 2 or 3 for increasing the maximum temperature. Desirable d is 0 for decreasing the viscosity, and is 1 for decreasing the minimum temperature.

In formula (4), P¹, P² and P³ are a polymerizable group. Desirable P¹, P² or P³ is group selected from polymerizable groups represented by formula (P-1) to formula (P-5). More desirable P¹ , P² or P³ is group (P-1) or group (P-2). Especially desirable group (P-1) is —OCO—CH═CH₂ or —oCO—C(CH₃)═CH₂. A wavy line in group (P-1) to group (P-5) shows a binding position.

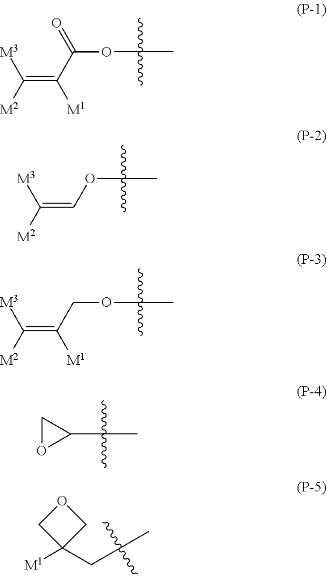

In group (P-1) to group (P-5), M¹, M² and M³ are hydrogen, fluorine, alkyl having 1 to 5 carbons or alkyl having 1 to 5 carbons in which at least one hydrogen has been replaced by fluorine or chlorine. Desirable M¹, M² or M³ is hydrogen or methyl for increasing the reactivity. More desirable M¹ is methyl, and more desirable M² or M³ is hydrogen.

In formula (4-1) to formula (4-29), P⁴, P⁵ and P⁶ are a group represented by formula (P-1) to formula (P-3). Desirable P⁴, P⁵ or P⁶ is group (P-1) or group (P-2). More desirable group (P-1) is —OCO—CH═CH₂ or —OCO—C(CH₃)═CH₂. A wavy line in group (P-1) to group (P-5) shows a binding position.

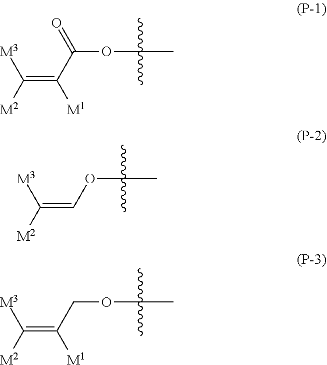

In formula (4), Sp¹, Sp² and Sp³ are a single bond or alkylene having 1 to 10 carbons, and in the alkylene at least one —CH₂— may be replaced by —O—, —COO—, —OCO— or —OCOO—, at least one —CH₂CH₂— may be replaced by —CH═CH— or —C≡C—, and in these groups at least one hydrogen may be replaced by fluorine or chlorine. Desirable Sp¹, Sp² or Sp³ is a single bond, —CH₂CH₂—, —CH₂O—, —OCH₂—, —COO—, —OCO—, —CO—CH═CH— or —CH═CH—CO—. More desirable Sp¹, Sp² or Sp³ is a single bond.

Ring J and ring L are cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine. Desirable ring J or ring L is phenyl. Ring K is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine. Desirable ring K is 1,4-phenylene or 2-fluoro-1,4-phenylene.

Z⁵ and Z⁶ are a single bond or alkylene having 1 to 10 carbons, and in the alkylene at least one —CH₂— may be replaced by —O—, —CO—, —COO— or —OCO—, at least one —CH₂CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine. Desirable Z⁵ or Z⁶ is a single bond, —CH₂CH₂—, —CH₂O—, —OCH₂—, —COO— or —OCO—. More desirable Z⁵ or Z⁶ is a single bond.

f is 0, 1 or 2. Desirable f is 0 or 1. g, h and j are 0, 1, 2, 3 or 4, and the sum of g, h and j is 1 or more. Desirable g, h or j is 1 or 2.

Fifth, desirable component compounds for light switching device will be shown. Desirable compound (1) is compound (1-1) to compound (1-13) according to item 2. It is desirable that in these compounds, at least one of the first component should be compound (1-1), compound (1-3), compound (1-5), compound (1-6), compound (1-7) or compound (1-8). It is desirable that at least two of the first component should be a combination of compound (1-1) and compound (1-5), compound (1-1) and compound (1-6), compound (1-1) and compound (1-7), compound (1-1) and compound (1-8), compound (1-3) and compound (1-5), compound (1-3) and compound (1-6), compound (1-3) and compound (1-7) or compound (1-3) and compound (1-8).

Desirable compound (2) is compound (2-1) to compound (2-35) according to item 5. It is desirable that in these compounds, at least one of the second component should be compound (2-4), compound (2-12), compound (2-14), compound (2-15), compound (2-17), compound (2-18), compound (2-23), compound (2-24), compound (2-27), compound (2-29) or compound (2-30). It is desirable that at least two of the second component should be a combination of compound (2-12) and compound (2-15), compound (2-14) and compound (2-27), compound (2-18) and compound (2-24), compound (2-18) and compound (2-29), compound (2-24) and compound (2-29) or compound (2-29) and compound (2-30).

Desirable compound (3) is compound (3-1) to compound (3-35) according to item 8. It is desirable that in these compounds, at least one of the third component should be compound (3-1), compound (3-3), compound (3-6), compound (3-8), compound (3-10), compound (3-14) or compound (3-34). It is desirable that at least two of the third component should be a combination of compound (3-1) and compound (3-8), compound (3-1) and compound (3-14), compound (3-3) and compound (3-8), compound (3-3) and compound (3-14), compound (3-3) and compound (3-34), compound (3-6) and compound (3-8), compound (3-6) and compound (3-10) or compound (3-6) and compound (3-14).

Desirable compound (4) is compound (4-1) to compound (4-29) according to item 12. It is desirable that in these compounds, at least one of the first additive should be compound (4-1), compound (4-2), compound (4-24), compound (4-25), compound (4-26) or compound (4-27). It is desirable that at least two of the first additive should be a combination of compound (4-1) and compound (4-2), compound (4-1) and compound (4-18), compound (4-2) and compound (4-24), compound (4-2) and compound (4-25), compound (4-2) and compound (4-26), compound (4-25) and compound (4-26) or compound (4-18) and compound (4-24).

A desirable compound is shown in view of a large optical anisotropy. When the compound has 1,4-phenylene, the optical anisotropy is relatively large. When the compound has two 1,4-phenylene, the optical anisotropy is large. It is desirable that in these compounds, 1,4-cyclohexylene should be fewer. The compound having three or more rings such as 1,4-phenylene is preferable to the compound having two. The compound having a triple bond, which is different from compound (1), compound (2) and compound (3), is desirable in view of a large optical anisotropy.

The composition having an optical anisotropy of approximately 0.25 or more or approximately 0.27 or more or approximately 0.30 or more, can be prepared by preferentially using desirable compounds in view of a large optical anisotropy. Desirable compound (1) is compound (1-3), compound (1-6), compound (1-8) or compound (1-13). Desirable compound (2) is compound (2-15), compound (2-16), compound (2-21), compound (2-22) or compound (2-29). Desirable compound (3) is compound (3-14), compound (3-16) or compound (3-19).

Sixth, additives that may be added to the composition will be explained. Such additives include an optically active compound, an antioxidant, an ultraviolet light absorber, a quencher, a coloring matter, an antifoaming agent, a polymerizable compound, a polymerization initiator, a polymerization inhibitor and a polar compound. The optically active compound is added to the composition for the purpose of inducing the helical structure of liquid crystal molecules and giving a twist angle. Examples of such compounds include compound (5-1) to compound (5-5). A desirable ratio of the optically active compound is approximately 5% or less, and a more desirable ratio is in the range of approximately 0.01% to approximately 2%.

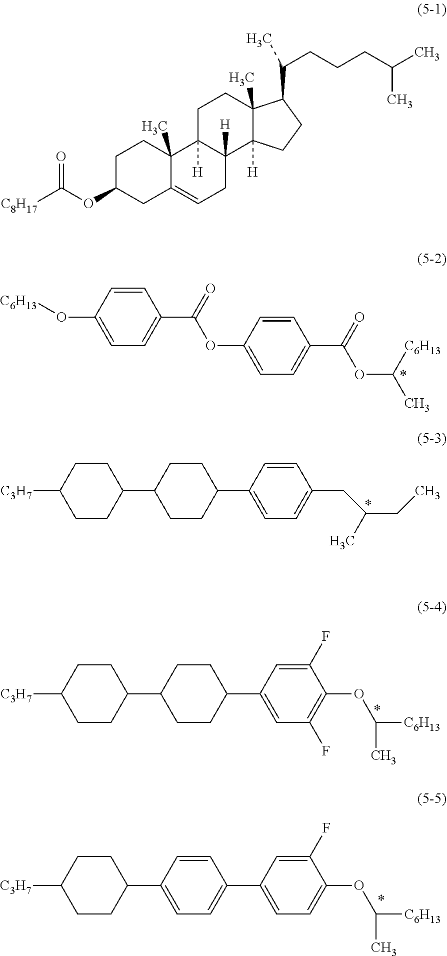

An antioxidant such as compound (6-1) to compound (6-3) may be added to the composition in order to prevent a decrease in specific resistance that is caused by heating under air, or to maintain a large voltage holding ratio at a temperature close to the maximum temperature as well as at room temperature, after the device has been used for a long time.

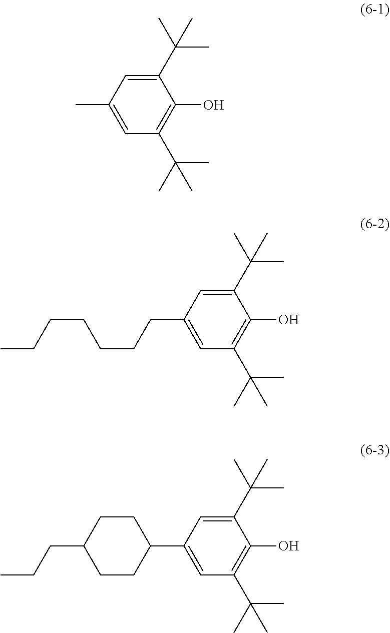

A compound having a small volatility is effective in maintaining a large voltage holding ratio at a temperature close to the maximum temperature as well as at room temperature, after the device has been used for a long time. A desirable ratio of the antioxidant is approximately 50 ppm or more for achieving its effect and is approximately 600 ppm or less for avoiding a decrease in the maximum temperature or avoiding an increase in the minimum temperature. A more desirable ratio is in the range of approximately 100 ppm to approximately 300 ppm.

Desirable examples of an ultraviolet light absorber include benzophenone derivatives, benzoate derivatives and triazole derivatives. A light stabilizer such as an amine having steric hindrance is also desirable. Examples of the light stabilizer are compound (7-1) to compound (7-16), and so forth. A desirable ratio of the absorber or the light stabilizer is approximately 50 ppm or more for achieving its effect and is approximately 10,000 ppm or less for avoiding a decrease in the maximum temperature or for avoiding an increase in the minimum temperature. A more desirable ratio is in the range of approximately 100 ppm to approximately 10,000 ppm.

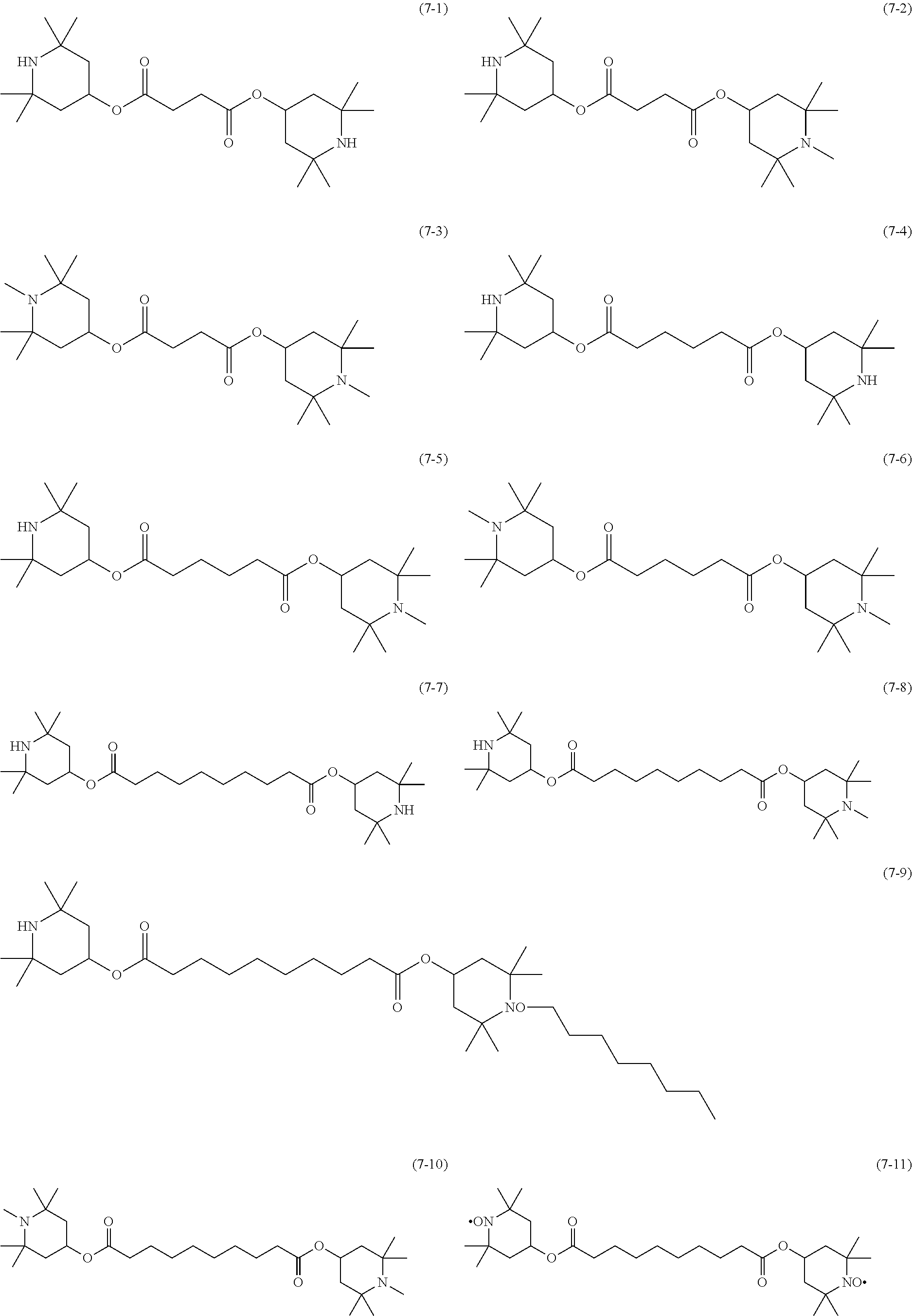

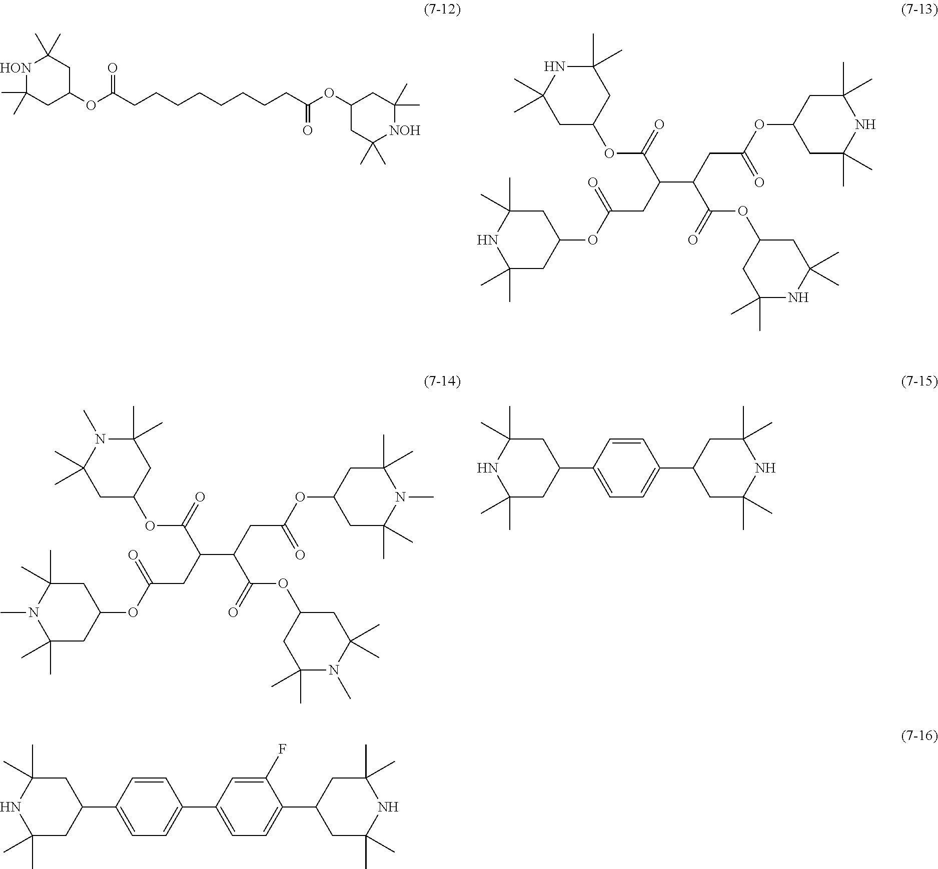

A quencher is a compound that prevents the decomposition of liquid crystal compounds, where light energy absorbed by the liquid crystal compound is accepted and converted to thermal energy. Desirable examples include compound (8-1) to compound (8-7). A desirable ratio of the quencher is approximately 50 ppm or more for achieving its effect, and approximately 20,000 ppm or less for avoiding an increase in the minimum temperature. A more desirable ratio is in the range of approximately 100 ppm to approximately 10,000 ppm.

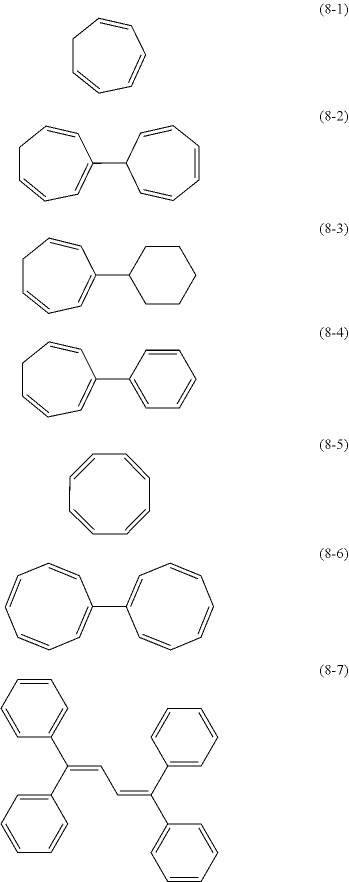

A dichroic dye such as an azo dye or an anthraquinone dye may be added to the composition for adjusting to a device having a guest host (GH) mode. A desirable ratio of the coloring matter is in the range of approximately 0.01% to approximately 10%. The antifoaming agent such as dimethyl silicone oil or methyl phenyl silicone oil is added to the composition for preventing foam formation. A desirable ratio of the antifoaming agent is approximately 1 ppm or more for achieving its effect and is approximately 1,000 ppm or less for preventing display defects. A more desirable ratio is in the range of approximately 1 ppm to approximately 500 ppm.

The polymerizable compound is used for adjusting to a device with a polymer sustained alignment mode. Compound (4) is suitable for this purpose. A polymerizable compound that is different from compound (4) may be added to the composition, in addition to compound (4). Desirable examples of such a polymerizable compound include compounds such as acrylates, methacrylates, vinyl compounds, vinyloxy compounds, propenyl ethers, epoxy compounds (oxiranes, oxetanes) and vinyl ketones. More desirable examples are acrylate derivatives or methacrylate derivatives.

The polymerizable compound such as compound (4) is polymerized on irradiation with ultraviolet light. It may be polymerized in the presence of an initiator such as a photopolymerization initiator. Suitable conditions for polymerization, and a suitable type and amount of the initiator are known to a person skilled in the art, and are described in the literature. For example, Irgacure 651 (registered trademark; BASF), Irgacure 184 (registered trademark; BASF) or Darocur 1173 (registered trademark; BASF), each of which is a photoinitiator, is suitable for radical polymerization. A desirable ratio of the photopolymerization initiator is in the range of approximately 0.1% to approximately 5% based on the total amount of the polymerizable compound. A more desirable ratio is in the range of approximately 1% to approximately 3%.

A polymerization inhibitor such as compound (4) may be added in order to prevent the polymerization when the polymerizable compound is kept in storage. The polymerizable compound is usually added to the composition without removing the polymerization inhibitor. Examples of the polymerization inhibitor include hydroquinone derivatives such as hydroquinone and methylhydroquinone, 4-t-butylcatechol, 4-methoxyphenol and phenothiazine.

Seventh, methods for synthesizing the component compounds will be explained. These compounds can be synthesized by known methods. The synthetic methods will be exemplified. Compound (1-1) is prepared by the method described in JP S59-176221 A (1984). Compound (2-18) is prepared by the method described in JP H10-251186 A (1998). Compound (3-1) is prepared by the method described in JP H02-503441 A (1990). Antioxidants are commercially available. Compound (6-1) is available from Sigma-Aldrich Corporation. Compound (6-2) and so forth are synthesized according to the method described in U.S. Pat. No. 3,660,505.

Compounds whose synthetic methods are not described can be prepared according to the methods described in books such as “Organic Syntheses” (John Wiley & Sons, Inc.), “Organic Reactions” (John Wiley & Sons, Inc.), “Comprehensive Organic Synthesis” (Pergamon Press), and “Shin-Jikken Kagaku Kouza” (New experimental Chemistry Course, in English; Maruzen Co., Ltd., Japan). The composition is prepared according to known methods using the compounds thus obtained. For example, the component compounds are mixed and dissolved in each other by heating.

Last, the use of the composition will be explained. The composition has mainly a minimum temperature of approximately −10° C. or lower, a maximum temperature of approximately 70° C. or higher, and an optical anisotropy in the range of approximately 0.07 to approximately 0.20. The composition having an optical anisotropy in the range of approximately 0.08 to approximately 0.25 may be prepared by adjusting the ratio of the component compounds, or by mixing with any other liquid crystal compound. A desirable composition has a large optical anisotropy. A composition having an optical anisotropy of approximately 0.25 or more or approximately 0.27 or more or approximately 0.30 or more may be prepared. A composition having a large optical anisotropy is prepared by preferentially using a compound having a large optical anisotropy. A light switching device having such a composition has a large voltage holding ratio.

The light switching device has a composition exhibiting a liquid crystal phase. The liquid crystal phase includes a nematic phase, a chiral nematic (cholesteric) phase, a smectic A phase, a smectic C phase, a chiral smectic C phase or a chiral smectic C_{A} phase. A nematic liquid crystal composition is suitable for the light switching device. A chiral nematic (cholesteric) liquid crystal composition is formed by the addition of an optically active compound to the nematic liquid crystal composition. The chiral nematic liquid crystal composition may be used for the light switching device. Similarly, a smectic A liquid crystal composition or a smectic C liquid crystal composition may be used for the light switching device. A chiral smectic C liquid crystal composition and a chiral smectic C_{A} liquid crystal composition may be used for a ferroelectric liquid crystal device and an antiferroelectric liquid crystal device, respectively. These devices may be used for the purpose of scanning the surroundings while changing the irradiation direction. The device has no mechanical driving parts. The device has an advantage where it is driven electrically. Therefore, the device is useful for the LIDAR technology and so forth.

### EXAMPLES

The disclosure will be explained in more detail by way of examples. The disclosure is not limited to the examples. The examples describe composition (M1), composition (M2) and so forth. In the examples, a mixture of composition (M1) and composition (M2) is not described. However, it should be considered that the mixture is also disclosed. It should be considered that a mixture of at least two compositions selected from examples is also disclosed. Compounds prepared herein were identified by methods such as NMR analysis. The characteristics of the compounds, compositions and devices were measured by the methods described below.

NMR Analysis: A model DRX-500 apparatus made by Bruker BioSpin Corporation was used for measurement. In the measurement of ¹H-NMR, a sample was dissolved in a deuterated solvent such as CDCl₃, and the measurement was carried out under the conditions of room temperature, 500 MHz and the accumulation of 16 scans. Tetramethylsilane was used as an internal standard. In the measurement of ¹⁹F-NMR, CFCl₃ was used as the internal standard, and 24 scans were accumulated. In the explanation of the nuclear magnetic resonance spectra, the symbols s, d, t, q, quin, sex, m and br stand for a singlet, a doublet, a triplet, a quartet, a quintet, a sextet, a multiplet and line-broadening, respectively.

Gas Chromatographic Analysis: A gas chromatograph Model GC-14B made by Shimadzu Corporation was used for measurement. The carrier gas was helium (2 milliliters per minute). The sample injector and the detector (FID) were set to 280° C. and 300° C., respectively. A capillary column DB-1 (length 30 meters, bore 0.32 millimeters, film thickness 0.25 micrometers, dimethylpolysiloxane as the stationary phase, non-polar) made by Agilent Technologies, Inc. was used for the separation of component compounds. After the column had been kept at 200° C. for 2 minutes, it was further heated to 280° C. at the rate of 5° C. per minute. A sample was dissolved in acetone (0.1%), and 1 microliter of the solution was injected into the sample injector. A recorder used was Model C-R5A Chromatopac Integrator made by Shimadzu Corporation or its equivalent. The resulting gas chromatogram showed the retention time of peaks and the peak areas corresponding to the component compounds.

Solvents for diluting the sample may also be chloroform, hexane and so forth. The following capillary columns may also be used in order to separate the component compounds: HP-1 made by Agilent Technologies Inc. (length 30 meters, bore 0.32 millimeters, film thickness 0.25 micrometers), Rtx-1 made by Restek Corporation (length 30 meters, bore 0.32 millimeters, film thickness 0.25 micrometers), and BP-1 made by SGE International Pty. Ltd. (length 30 meters, bore 0.32 millimeters, film thickness 0.25 micrometers). A capillary column CBP1-M50-025 (length 50 meters, bore 0.25 millimeters, film thickness 0.25 micrometers) made by Shimadzu Corporation may also be used for the purpose of avoiding an overlap of peaks of the compounds.

The ratio of the liquid crystal compounds included in the composition may be calculated according to the following method. A mixture of the liquid crystal compounds is analyzed by gas chromatography (FID). The ratio of peak areas in the gas chromatogram corresponds to the ratio of the liquid crystal compounds. When the capillary columns described above are used, the correction coefficient of respective liquid crystal compounds may be regarded as 1 (one). Accordingly, the ratio of the liquid crystal compounds can be calculated from the ratio of peak areas.

Samples for measurement: A composition itself was used as a sample when the characteristics of the composition or the device were measured. When the characteristics of a compound were measured, a sample for measurement was prepared by mixing this compound (15%) with mother liquid crystals (85%). The characteristic values of the compound were calculated from the values obtained from measurements by an extrapolation method: (Extrapolated value)=(Measured value of sample)−0.85×(Measured value of mother liquid crystals)/0.15. When a smectic phase (or crystals) was deposited at 25° C. at this ratio, the ratio of the compound to the mother liquid crystals was changed in the order of (10%: 90%), (5%: 95%) and (1%: 99%). The values of the maximum temperature, the optical anisotropy, the viscosity and the dielectric anisotropy regarding the compound were obtained by means of this extrapolation method.

The following mother liquid crystals A were used for a compound having positive dielectric anisotropy.

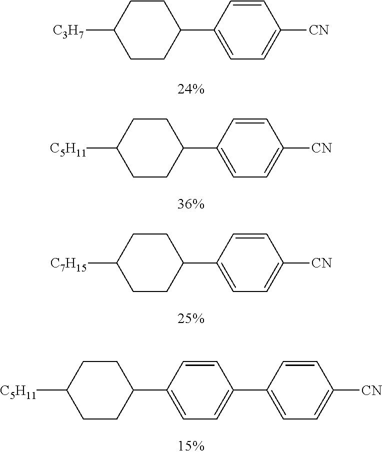

The following mother liquid crystals B were used for a compound having negative dielectric anisotropy.

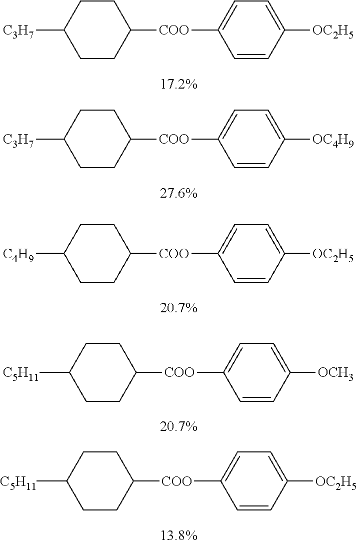

The dielectric anisotropy of compound (1) is almost 0 (zero). One of mother liquid crystal crystals A and the mother liquid crystal crystals B was used for such a compound.

Measurement methods: The characteristics of compounds were measured according to the following methods. Most are methods described in the JEITA standards (JEITA-ED-2521B) which was deliberated and established by Japan Electronics and Information Technology Industries Association (abbreviated to JEITA), or their modified methods. No thin film transistors (TFT) were attached to a TN device used for measurement.

(1) Maximum temperature of a nematic phase (NI; ° C.): A sample was placed on a hot plate in a melting point apparatus equipped with a polarizing microscope and was heated at the rate of 1° C. per minute. The temperature was measured when a part of the sample began to change from a nematic phase to an isotropic liquid. The maximum temperature of a nematic phase is sometimes abbreviated to the “maximum temperature”.
(2) Minimum temperature of a nematic phase (Tc; ° C.): A sample having a nematic phase was placed in glass vials and then kept in freezers at temperatures of 0° C., −10° C., −20° C., −30° C. and −40° C. for 10 days, and then the liquid crystal phases were observed. For example, when the sample maintained the nematic phase at −20° C. and changed to crystals or a smectic phase at −30° C., Tc was expressed as <−20° C. A lower limit of the temperature range of a nematic phase is sometimes abbreviated to “the minimum temperature”.
(3) Viscosity (bulk viscosity; η; measured at 20° C.; mPa·s): An E-type viscometer made by Tokyo Keiki Inc. was used for measurement.
(4a) Viscosity (rotational viscosity; γ1; measured at 25° C.; mPa·s; for a sample having negative dielectric anisotropy): A rotational viscosity measuring system LCM-2 type made by Toyo Corporation was used for measurement. A sample was placed in a VA device in which the distance between the two glass substrates (cell gap) was 10 micrometers. Rectangular waves (55 V, 1 ms) was applied to this device. The peak current and the peak time of the transient current generated by the applied voltage were measured. The value of rotational viscosity was obtained from these measured values and the dielectric anisotropy. The dielectric anisotropy was measured according to measurement (6).
(4b) Viscosity (rotational viscosity; γ1; measured at 25° C.; mPa·s; for a sample having positive dielectric anisotropy): The measurement was carried out according to the method described in M. Imai, et al., Molecular Crystals and Liquid Crystals, Vol. 259, 37 (1995). A sample was placed in a TN device in which the twist angle was 0 degrees and the distance between the two glass substrates (cell gap) was 5 micrometers. A voltage was applied to this device and increased stepwise with an increment of 0.5 volt in the range of 16 to 19.5 volts. After a period of 0.2 seconds with no voltage, a voltage was applied repeatedly under the conditions of a single rectangular wave alone (rectangular pulse; 0.2 seconds) and of no voltage (2 seconds). The peak current and the peak time of the transient current generated by the applied voltage were measured. The value of rotational viscosity was obtained from these measured values and the calculating equation (10) on page 40 of the paper presented by M. Imai, et al. The value of dielectric anisotropy necessary for this calculation was measured with the device used for measuring this rotational viscosity by the method described below.
(5) Optical anisotropy (refractive index anisotropy; An; measured at 25° C.): The measurement was carried out using an Abbe refractometer with a polarizing plate attached to the ocular, using light at a wavelength of 589 nanometers. The surface of the main prism was rubbed in one direction, and then a sample was placed on the main prism. The refractive index (n∥) was measured when the direction of the polarized light was parallel to that of rubbing. The refractive index (n⊥) was measured when the direction of polarized light was perpendicular to that of rubbing. The value of the optical anisotropy (Δn) was calculated from the equation: Δn=n∥−n⊥.
(6a) Dielectric anisotropy (Δϵ; measured at 25° C.; for a sample having negative dielectric anisotropy): The value of dielectric anisotropy was calculated from the equation: Δϵ=ϵ∥−ϵ⊥. The dielectric constants (ϵ∥ and ϵ⊥) were measured as follows.
1) Measurement of a dielectric constant (ϵ∥): A solution of octadecyltriethoxysilane (0.16 mL) in ethanol (20 mL) was applied to thoroughly cleaned glass substrates. The glass substrates were rotated with a spinner, and then heated at 150° C. for one hour. A sample was placed in a VA device in which the distance between the two glass substrates (cell gap) was 4 micrometers, and then this device was sealed with a UV-curable adhesive. Sine waves (0.5 V, 1 kHz) were applied to this device, and the dielectric constant (ϵ∥) in the major axis direction of liquid crystal molecules was measured after 2 seconds.
2) Measurement of a dielectric constant (ϵ⊥): A polyimide solution was applied to thoroughly cleaned glass substrates. The glass substrates were calcined, and then the resulting alignment film was subjected to rubbing. A sample was placed in a TN device in which the distance between the two glass substrates (cell gap) was 9 micrometers and the twist angle was 80 degrees. Sine waves (0.5 V, 1 kHz) were applied to this device, and the dielectric constant (ϵ⊥) in the minor axis direction of liquid crystal molecules was measured after 2 seconds.
(6b) Dielectric anisotropy (Δϵ; measured at 25° C.; for a sample having positive dielectric anisotropy): A sample was placed in a TN device in which the distance between the two glass substrates (cell gap) was 9 micrometers and the twist angle was 80 degrees. Sine waves (10 V, 1 kHz) were applied to this device, and the dielectric constant (ϵ∥) in the major axis direction of liquid crystal molecules was measured after 2 seconds. Sine waves (0.5 V, 1 kHz) were applied to this device and the dielectric constant (ϵ⊥) in the minor axis direction of the liquid crystal molecules was measured after 2 seconds. The value of dielectric anisotropy was calculated from the equation: Δϵ=ϵ∥−ϵ⊥.
(7a) Threshold voltage (Vth; measured at 25° C.; V; for a sample having negative dielectric anisotropy): An LCD evaluation system Model LCD-5100 made by Otsuka Electronics Co., Ltd. was used for measurement. The light source was a halogen lamp. A sample was placed in a VA device with a normally black mode, in which the distance between the two glass substrates (cell gap) was 4 micrometers and the rubbing direction was antiparallel, and then this device was sealed with a UV-curable adhesive. The voltage to be applied to this device (60 Hz, rectangular waves) was stepwise increased in 0.02 V increments from 0 V up to 20 V. During the increase, the device was vertically irradiated with light, and the amount of light passing through the device was measured. A voltage-transmittance curve was prepared, in which the maximum amount of light corresponded to 100% transmittance and the minimum amount of light corresponded to 0% transmittance. The threshold voltage was expressed as voltage at 10% transmittance.
(7b) Threshold voltage (Vth; measured at 25° C.; V; for a sample having positive dielectric anisotropy): An LCD evaluation system Model LCD-5100 made by Otsuka Electronics Co., Ltd. was used for measurement. The light source was a halogen lamp. A sample was placed in a TN device having a normally white mode, in which the distance between the two glass substrates (cell gap) was 0.45/Δn (micrometer) and the twist angle was 80 degrees. A voltage to be applied to this device (32 Hz, rectangular waves) was stepwise increased in 0.02 V increments from 0 V up to 10 V. During the increase, the device was vertically irradiated with light, and the amount of light passing through the device was measured. A voltage-transmittance curve was prepared, in which the maximum amount of light corresponded to 100% transmittance and the minimum amount of light corresponded to 0% transmittance. The threshold voltage was expressed as voltage at 90% transmittance.
(8) Voltage holding ratio (VHR-1; measured at 25° C.; %): A TN device used for measurement had a polyimide-alignment film, and the distance between the two glass substrates (cell gap) was 5 micrometers. A sample was placed in the device, and then this device was sealed with a UV-curable adhesive. For a sample having negative dielectric anisotropy, a pulse voltage (60 microseconds at 5 V) was applied to this device and the device was charged. For a sample having positive dielectric anisotropy, a pulse voltage (60 microseconds at 1 V) was applied to this device and the device was charged. A decreasing voltage was measured for 16.7 microseconds with a high-speed voltmeter, and area A between the voltage curve and the horizontal axis in a unit cycle was obtained. Area B was an area without the decrease. The voltage holding ratio was expressed as a percentage of area A to area B.
(9) Voltage holding ratio (VHR-2; measured at 60° C.; %): The voltage holding ratio (VHR-2) was measured by the method described in measurement (8), except that it was measured at 60° C. instead of 25° C.
(10) Voltage Holding Ratio (VHR-3; measured at 25° C.; %): The stability to ultraviolet light was evaluated by measuring a voltage holding ratio after irradiation with ultraviolet light. A TN device used for measurement had a polyimide-alignment film and the cell gap was 5 micrometers. A sample was poured into this device, and then the device was irradiated with light for 20 minutes. The light source was an ultra-high-pressure mercury lamp USH-500D (produced by Ushio, Inc.), and the distance between the device and the light source was 20 centimeters. In the measurement of VHR-3, a decreasing voltage was measured for 16.7 milliseconds. A composition having a large VHR-3 has a high stability to ultraviolet light. The value of VHR-3 is preferably 90% or more, and more preferably 95% or more.
(11) Voltage holding ratio (VHR-4; measured at 25° C.; %): A TN device into which a sample was poured was heated in a constant-temperature bath at 120° C. for 20 hours, and then the stability to heat was evaluated by measuring the voltage holding ratio. In the measurement of VHR-4, a decreasing voltage was measured for 16.7 milliseconds. A composition having a large VHR-4 has a high stability to heat.
(12a) Response time (T; measured at 25° C.; ms; for a sample having negative dielectric anisotropy): An LCD evaluation system Model LCD-5100 made by Otsuka Electronics Co., Ltd. was used for measurement. The light source was a halogen lamp. The low-pass filter was set at 5 kHz. A sample was placed in a VA device with a normally black mode in which the distance between the two glass substrates (cell gap) was 4 micrometers. This device was sealed with a UV-curable adhesive. Rectangular waves (60 Hz, 10 V, 0.5 seconds) were applied to this device. The device was vertically irradiated with light simultaneously, and the amount of light passing through the device was measured. The transmittance was regarded as 100% when the amount of light reached a maximum. The transmittance was regarded as 0% when the amount of light reached a minimum. The response time was expressed as the period of time required for the change from 90% to 10% transmittance (fall time: millisecond).
(12b) Response time (T; measured at 25° C.; millisecond; for a sample having positive dielectric anisotropy): The measurement was carried out with an LCD evaluation system Model LCD-5100 made by Otsuka Electronics Co., Ltd. The light source was a halogen lamp. The low-pass filter was set at 5 kHz. A sample was placed in a TN device having a normally white mode, in which the distance between the two glass substrates (cell gap) was 5.0 micrometers and the twist angle was 80 degrees. Rectangular waves (60 Hz, 5 V, 0.5 seconds) were applied to this device. The device was simultaneously irradiated with light in the perpendicular direction, and the amount of light passing through the device was measured. The transmittance was regarded as 100% when the amount of light reached a maximum. The transmittance was regarded as 0% when the amount of light reached a minimum. Rise time (Tr; millisecond) was the time required for a change from 90% to 10% transmittance. Fall time (if; millisecond) was the time required for a change from 10% to 90% transmittance. The response time was expressed as the sum of the rise time and the fall time thus obtained.
(13) Specific resistance (p; measured at 25° C.; Ωcm): A sample of 1.0 milliliter was placed in a vessel equipped with electrodes. A DC voltage (10 V) was applied to the vessel, and the DC current was measured after 10 seconds. The specific resistance was calculated from the following equation: (specific resistance)=[(voltage)×(electric capacity of vessel)]/[(DC current)×(dielectric constant in vacuum)].
(14) Line residual image (line image sticking parameter; LISP; %): A display device was stressed electrically to give line residual images. The brightness in the area where line residual images were present and the brightness in the residual area (the reference area) were measured. The ratio of a brightness decrease caused by the line residual images was calculated, and the magnitude of the line residual images was expressed by this ratio.
(14-1) Measurement of brightness: Images of the device was photographed with Imaging colorimeters and photometer PM-1433F-0 made by Radiant Zemax. The images were analyzed using ProMetric 9.1 Software made by Radiant Imaging, to calculate the brightness of each area in the device. A LED backlight where the average brightness was 3500 cd/m² was used for a light source.
(14-2) Setting of stress voltage: A sample was placed into an FFS device (16 cells; 4 cells vertically and 4 cells horizontally) having a matrix structure in which the cell gap was 3.5 micrometers, and the device was sealed with a UV-curable adhesive. Polarizing plates were arranged over and under the device in order that the polarizing axes were intersected at right angles. The device was irradiated with light, and a voltage (rectangular wave, 60 Hz) was applied. The voltage was in the range of 0 V to 7.5 V was applied stepwise with an increment of 0.1 volt, and the brightness of the transmitted light was measured at each voltage. A voltage at the maximum brightness was abbreviated to V255. A voltage at the brightness being 21.6% of V255 (namely 127 gradation) was abbreviated to V127.
(14-3) Conditions of stress: V255 (rectangular wave, 30 Hz) was applied to the stressed area and 0.5 V (rectangular wave, 30 Hz) were applied to the reference area, under the conditions of 60° C. and 23 hours, giving a checker pattern. Next, V127 (rectangular wave, 0.25 Hz) was applied, and the brightness was measured under the conditions of exposure time being 4000 milliseconds.
(14-4) Calculation of line residual images: The central 4 cells (vertical 2 cells and horizontal 2 cells) were used for the calculation. The 4 cells were divided into 25 areas (vertical 5 cells and horizontal 5 cells). The average brightness of 4 areas in the four corners (vertical 2 cells and horizontal 2 cells) was abbreviated to brightness A. Areas formed by excluding the four corner-areas from 25 areas were cross-shaped. In four areas formed by excluding the central intersecting area from the cross-shaped area, the minimum value of the brightness was abbreviated to brightness B. The line residual images were calculated from the following equation: (line residual images)=(brightness A−brightness B)/brightness A×100. It is desirable that the line residual images should be smaller.
(15) Spread: The spread of an additive was qualitatively evaluated by applying a voltage to a device and measuring the brightness. The measurement of the brightness was carried out in the same manner as with measurement (14-1) described above. The setting of a voltage (V127) was carried out in the same manner as with measurement (14-2) described above, with the proviso that a VA device was used instead of an FFS device. The brightness was measured as follows. First, a DC current (2 V) was applied for 2 minutes. Next, V127 (rectangular wave, 0.05 Hz) was applied, and the brightness was measured under the conditions of exposure time being 4000 milliseconds. The spread was evaluated from the results.
(16) Elastic constants (K; measured at 25° C.; pN): An LCR meter Model HP 4284-A made by Yokokawa Hewlett-Packard, Ltd. was used for measurement. A sample was placed into a homogeneous device in which the distance between the two glass substrates (cell gap) was 20 micrometers. An electric charge of 0 V to 20 V was applied to this device, and the electrostatic capacity and the applied voltage were measured. The measured values of the electric capacity (C) and the applied voltage (V) were fitted to equation (2.98) and equation (2.101) on page 75 of “Ekisho Debaisu Handobukku” (Liquid Crystal Device Handbook, in English; The Nikkan Kogyo Shimbun, Ltd., Japan) and the values of K11 and K33 were obtained from equation (2.99). Next, the value of K22 was calculated from equation (3.18) on page 171 of the book and the values of K11 and K33 thus obtained. The elastic constant K was expressed as an average of K11, K22 and K33.
(17) Dielectric constant in the minor axis direction (el; measured at 25° C.): A sample was placed into a TN device in which the distance between the two glass substrates (cell gap) was 9 micrometers and the twist angle was 80 degrees. Sine waves (0.5 V, 1 kHz) were applied to this device and the dielectric constant (ϵ⊥) in the minor axis direction of liquid crystal molecules was measured after 2 seconds.

Examples of compositions will be shown below. Component compounds were expressed in terms of symbols, based on the definition in Table 3 described below. In Table 3, the configuration of 1,4-cyclohexylene is trans. The parenthesized number next to a symbolized compound represents the chemical formula to which the compound belongs. The symbol (-) means any other liquid crystal compound. Last, the values of characteristics of the composition are summarized.

TABLE 3
Method of Description of Compounds using Symbols
R—(A₁)—Z₁—.....—Zₙ—(Aₙ)—R′

| 1) Left-terminal Group R— | Symbol |
|---|---|
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF- |
| CF₂═CH—CₙH₂ₙ— | VFFn- |
| F—CₙH₂ₙ— | Fn- |
| 2) Left-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | -nV |
| —CₙH₂ₙ—CH═CH—CₘH₂ₘ₊₁ | -nVm |
| —CH═CF₂ | —VFF |
| —COOCH₃ | -EMe |
| —F | —F |
| —Cl | —CL |
| —OCF₃ | —OCF3 |
| —CF₃ | —CF3 |
| —CN | —C |
| 3) Bonding Group —Zₙ— | Symbol |
| —CₙH₂ₙ— | n |
| —COO— | E |
| —CH═CH— | V |
| —C≡C— | T |
| —CF₂O— | X |
| —CH₂O— | 1O |
| 4) Ring Structure —Aₙ— | Symbol |
| 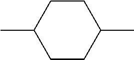 | H |
| 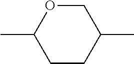 | Dh |
| 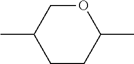 | dh |
| 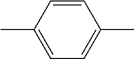 | B |
| 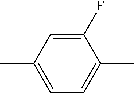 | B(F) |
| 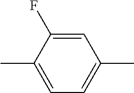 | B(2F) |
| 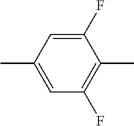 | B(F,F) |
| 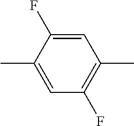 | B(2F,5F) |
| 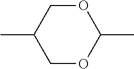 | G |
| 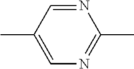 | Py |
| 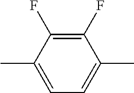 | B(2F,3F) |
| 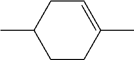 | ch |
| 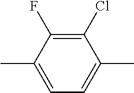 | B(2F,3Cl) |
| 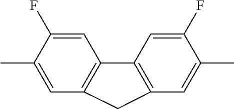 | FLF4 |
| 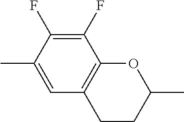 | Cro(7F,8F) |
| 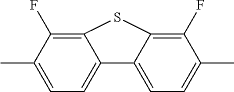 | DBTF2 |

5) Examples of Description
Example 1. 3-HH-V1

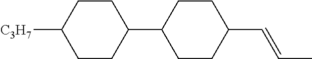

Example 2. 4-GB(F)B(F,F)XB(F,F)-F

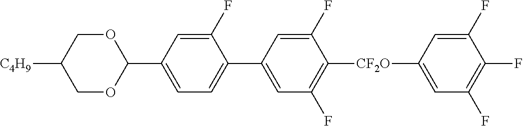

### Composition (M1)

| | | |
|---|---|---|
| 3-HH-V | (1-1) | 22% |
| 3-HH-V1 | (1-1) | 10% |
| 5-HB-O2 | (1-2) | 5% |
| 3-HHEH-3 | (1-4) | 3% |
| 3-HBB-2 | (1-6) | 7% |
| 5-B(F)BB-3 | (1-7) | 3% |
| 5-HXB(F,F)-F | (2-1) | 3% |
| 3-HHXB(F,F)-F | (2-4) | 6% |
| 3-HGB(F,F)-F | (2-6) | 3% |
| 3-HB(F)B(F,F)-F | (2-9) | 5% |
| 3-BB(F,F)XB(F,F)-F | (2-18) | 6% |
| 3-HHBB(F,F)-F | (2-19) | 6% |
| 5-BB(F)B(F,F)XB(F)B(F,F)-F | (2-31) | 2% |
| 3-BB(2F,3F)XB(F,F)-F | (2-32) | 4% |
| 3-HHB(F,F)XB(F,F)-F | (2) | 4% |
| 3-HBB(2F,3F)XB(F,F)-F | (2) | 5% |
| 3-HB-CL | (2) | 3% |
| 3-HHB-OCF3 | (2) | 3% |

NI=77.2° C.; Tc<−20° C.; Δn=0.101; Δϵ=5.8; Vth=1.88 V; η=13.7 mPa·s; γ1=61.3 mPa·s.

### Composition (M2)

| | | |
|---|---|---|
| 2-HH-5 | (1-1) | 8% |
| 3-HH-V | (1-1) | 10% |
| 3-HH-V1 | (1-1) | 7% |
| 4-HH-V | (1-1) | 10% |
| 4-HH-V1 | (1-1) | 8% |
| 5-HB-O2 | (1-2) | 7% |
| 4-HHEH-3 | (1-4) | 3% |
| V2-BB(F)B-1 | (1-8) | 3% |
| 5-HXB(F,F)-F | (2-1) | 6% |
| 3-HHXB(F,F)-F | (2-4) | 6% |
| V-HB(F)B(F,F)-F | (2-9) | 5% |
| 3-HHB(F)B(F,F)-F | (2-20) | 7% |
| 2-BB(F)B(F,F)XB(F)-F | (2-28) | 3% |
| 3-BB(F)B(F,F)XB(F)-F | (2-28) | 3% |
| 4-BB(F)B(F,F)XB(F)-F | (2-28) | 4% |
| 5-HB-CL | (2) | 5% |
| 1O1-HBBH-3 | (—) | 5% |

NI=78.5° C.; Tc<−20° C.; Δn=0.095; Δϵ=3.4; Vth=1.50 V; η=8.4 mPa·s; γ1=54.2 mPa·s.

### Composition (M3)

| | | |
|---|---|---|
| 2-HH-3 | (1-1) | 8% |
| 3-HH-V | (1-1) | 20% |
| 3-HH-V1 | (1-1) | 7% |
| 4-HH-V | (1-1) | 6% |
| 5-HB-O2 | (1-2) | 5% |
| V2-B2BB-1 | (1-9) | 3% |
| 3-HHEBH-3 | (1-11) | 5% |
| 3-HHEBH-5 | (1-11) | 5% |
| 3-HHEB(F,F)-F | (2-3) | 5% |
| 3-HHXB(F,F)-F | (2-4) | 7% |
| 5-HBEB(F,F)-F | (2-10) | 5% |
| 3-BB(F,F)XB(F,F)-F | (2-18) | 10% |
| 2-HHB(F)B(F,F)-F | (2-20) | 3% |
| 5-HHB(F,F)XB(F,F)-F | (2) | 6% |
| 3-HBB(2F,3F)XB(F,F)-F | (2) | 5% |

NI=90.3° C.; Tc<−20° C.; Δn=0.088; Δϵ=5.4; Vth=1.69 V; η=13.7 mPa·s; γ1=60.6 mPa·s.

### Composition (M4)

| | | |
|---|---|---|
| 2-HH-3 | (1-1) | 14% |
| 2-HH-5 | (1-1) | 4% |
| 3-HH-V | (1-1) | 26% |
| 1V2-HH-3 | (1-1) | 5% |
| 1V2-BB-1 | (1-3) | 3% |
| 3-HB(F)HH-2 | (1-10) | 4% |
| 5-HBB(F)B-2 | (1-13) | 6% |
| 3-BB(2F,5F)B-3 | (1) | 3% |
| 3-HGB(F,F)-F | (2-6) | 3% |
| 5-GHB(F,F)-F | (2-7) | 4% |
| 3-GB(F,F)XB(F,F)-F | (2-14) | 5% |
| 3-BB(F)B(F,F)-CF3 | (2-16) | 2% |
| 3-HHBB(F,F)-F | (2-19) | 4% |
| 3-GBB(F)B(F,F)-F | (2-22) | 2% |
| 2-dhBB(F,F)XB(F,F)-F | (2-25) | 4% |
| 3-HGB(F,F)XB(F,F)-F | (2) | 5% |
| 3-dhB(F,F)B(F,F)XB(F)B(F,F)-F | (2) | 3% |
| 7-HB(F,F)-F | (2) | 3% |

NI=78.3° C.; Tc<−20° C.; Δn=0.094; Δϵ=5.9; Vth=1.25 V; η=12.8 mPa·s; γ1=61.9 mPa·s.

### Composition (M5)

| | | |
|---|---|---|
| 3-HH-V | (1-1) | 30% |
| 3-HH-V1 | (1-1) | 10% |
| 1V2-HH-3 | (1-1) | 8% |
| 3-HH-VFF | (1-1) | 8% |
| V2-BB-1 | (1-3) | 2% |
| 5-HB(F)BH-3 | (1-12) | 5% |
| 5-HBBH-3 | (1) | 5% |
| 3-HHB(F,F)-F | (2-2) | 8% |
| 3-GB(F)B(F,F)-F | (2-12) | 3% |
| 3-BB(F,F)XB(F,F)-F | (2-18) | 10% |
| 3-GB(F)B(F,F)XB(F,F)-F | (2-27) | 6% |
| 5-GB(F,F)XB(F)B(F,F)-F | (2) | 5% |

NI=76.6° C.; Tc<−20° C.; Δn=0.088; Δϵ=5.5; Vth=1.81 V; η=12.1 mPa·s; γ1=60.2 mPa·s.

### Composition (M6)

| | | |
|---|---|---|
| 2-HH-5 | (1-1) | 5% |
| 3-HH-V | (1-1) | 30% |
| 3-HH-V1 | (1-1) | 3% |
| 3-HH-VFF | (1-1) | 10% |
| 3-HHB-1 | (1-5) | 4% |
| 3-HHB-3 | (1-5) | 5% |
| 3-HHB-O1 | (1-5) | 3% |
| 3-HHEBH-3 | (1-11) | 3% |
| 3-HHEBH-4 | (1-11) | 4% |
| 3-HHEBH-5 | (1-11) | 3% |
| 3-BB(2F,5F)B-3 | (1) | 3% |
| 3-BB(F,F)XB(F,F)-F | (2-18) | 14% |
| 3-dhB(F,F)B(F,F)XB(F)B(F,F)-F | (2) | 7% |
| 7-HB(F,F)-F | (2) | 6% |

NI=82.7° C.; Tc<−20° C.; Δn=0.085; Δϵ=5.1; Vth=1.70 V; η=8.0 mPa·s; γ1=53.9 mPa·s.

### Composition (M7)

| | | |
|---|---|---|
| 2-HH-5 | (1-1) | 8% |
| 3-HH-V | (1-1) | 28% |
| 4-HH-V1 | (1-1) | 7% |
| 5-HB-O2 | (1-2) | 2% |
| 7-HB-1 | (1-2) | 5% |
| VFF-HHB-O1 | (1-5) | 8% |
| VFF-HHB-1 | (1-5) | 3% |
| 3-HBB(F,F)-F | (2-8) | 5% |
| 5-HBB(F,F)-F | (2-8) | 4% |
| 3-BB(F)B(F,F)-F | (2-15) | 3% |
| 3-BB(F)B(F,F)XB(F,F)-F | (2-29) | 3% |
| 4-BB(F)B(F,F)XB(F,F)-F | (2-29) | 5% |
| 3-BB(F,F)XB(F)B(F,F)-F | (2-30) | 3% |
| 5-BB(F)B(F,F)XB(F)B(F,F)-F | (2-31) | 4% |
| 3-HH2BB(F,F)-F | (2) | 3% |
| 4-HH2BB(F,F)-F | (2) | 3% |
| 3-HBB(2F,3F)-O2 | (3-14) | 2% |
| 2-BB(2F,3F)B-3 | (3-19) | 4% |

NI=81.9° C.; Tc<−20° C.; Δn=0.109; Δϵ=4.8; Vth=1.75 V; η=13.3 mPa·s; γ1=57.4 mPa·s.

### Composition (M8)

| | | |
|---|---|---|
| 3-HH-5 | (1-1) | 4% |
| 3-HH-V | (1-1) | 21% |
| 3-HH-V1 | (1-1) | 3% |
| 4-HH-V | (1-1) | 4% |
| 1V2-HH-3 | (1-1) | 6% |
| 5-B(F)BB-2 | (1-7) | 3% |
| 5-B(F)BB-3 | (1-7) | 2% |
| 3-HHEB(F,F)-F | (2-3) | 4% |
| 3-HBEB(F,F)-F | (2-10) | 3% |
| 5-HBEB(F,F)-F | (2-10) | 3% |
| 3-BB(F)B(F,F)-F | (2-15) | 3% |
| 3-HBBXB(F,F)-F | (2-23) | 6% |
| 3-GB(F)B(F,F)XB(F,F)-F | (2-27) | 5% |
| 4-GB(F)B(F,F)XB(F,F)-F | (2-27) | 5% |
| 5-HHB(F,F)XB(F,F)-F | (2) | 3% |
| 3-HGB(F,F)XB(F,F)-F | (2) | 4% |
| 5-HEB(F,F)-F | (2) | 3% |
| 5-HB-CL | (2) | 2% |
| 3-HHB-OCF3 | (2) | 4% |
| 3-HB(2F,3F)-O2 | (3-1) | 3% |
| 3-BB(2F,3F)-O2 | (3-6) | 2% |
| 3-HHB(2F,3F)-O2 | (3-8) | 4% |
| F3-HH-V | (—) | 3% |

NI=78.1° C.; Tc<−20° C.; Δn=0.100; Δϵ=6.6; Vth=1.50 V; η=16.2 mPa·s; γ1=61.8 mPa·s.

### Composition (M9)

| | | |
|---|---|---|
| V-HH-V | (1-1) | 10% |
| V-HH-2V | (1-1) | 20% |
| 1V-HH-V | (1-1) | 10% |
| 3-HH-V | (1-1) | 15% |
| V2-BB-1 | (1-3) | 4% |
| 1-BB(F)B-2V | (1-8) | 7% |
| 2-BB(F)B-2V | (1-8) | 8% |
| 3-HHEB(F,F)-F | (2-3) | 3% |
| 3-HBEB(F,F)-F | (2-10) | 3% |
| 3-BB(F,F)XB(F,F)-F | (2-18) | 4% |
| 3-HHB(F)B(F,F)-F | (2-20) | 3% |
| 3-BB(F)B(F,F)XB(F,F)-F | (2-29) | 5% |
| 4-BB(F)B(F,F)XB(F,F)-F | (2-29) | 5% |
| 1O1-HBBH-5 | (—) | 3% |

NI=74.3° C.; Tc≤−20° C.; Δn=0.111; Δϵ32 3.0; Vth=2.39 V; η=11.0 mPa·s; γ1=44.5 mPa·s.

### Composition (M10)

| | | |
|---|---|---|
| 3-HH-V | (1-1) | 11% |
| 1-BB-3 | (1-3) | 6% |
| 3-HHB-1 | (1-5) | 4% |
| 3-HHB-O1 | (1-5) | 4% |
| 3-HBB-2 | (1-6) | 4% |
| 3-B(F)BB-2 | (1-7) | 4% |
| 3-HB(2F,3F)-O4 | (3-1) | 6% |
| 3-H2B(2F,3F)-O2 | (3-2) | 8% |
| 3-H10B(2F,3F)-O2 | (3-3) | 5% |
| 3-BB(2F,3F)-O2 | (3-6) | 10% |
| 2-HHB(2F,3F)-O2 | (3-8) | 7% |
| 3-HHB(2F,3F)-O2 | (3-8) | 7% |
| 5-HHB(2F,3F)-O2 | (3-8) | 7% |
| 2-HBB(2F,3F)-O2 | (3-14) | 4% |
| 3-HBB(2F,3F)-O2 | (3-14) | 7% |
| 5-HBB(2F,3F)-O2 | (3-14) | 6% |

NI=87.6° C.; Tc<−20° C.; Δn=0.126; Δϵ=−4.5; η=25.3 mPa·s.

### Composition (M11)

| | | |
|---|---|---|
| 3-HH-V | (1-1) | 27% |
| 3-HH-V1 | (1-1) | 6% |
| V-HHB-1 | (1-5) | 5% |
| 3-HB(2F,3F)-O2 | (3-1) | 5% |
| 5-HB(2F,3F)-O2 | (3-1) | 7% |
| 3-BB(2F,3F)-O2 | (3-6) | 8% |
| 3-HHB(2F,3F)-O2 | (3-8) | 5% |
| 5-HHB(2F,3F)-O2 | (3-8) | 4% |
| 3-HH10B(2F,3F)-O2 | (3-10) | 5% |
| 2-HBB(2F,3F)-O2 | (3-14) | 3% |
| 3-HBB(2F,3F)-O2 | (3-14) | 9% |
| 4-HBB(2F,3F)-O2 | (3-14) | 4% |
| 5-HBB(2F,3F)-O2 | (3-14) | 8% |
| 2-BB(2F,3F)B-3 | (3-19) | 4% |

NI=81.2° C.; Tc<−20° C.; Δn=0.107; Δϵ=−3.2; η=15.5 mPa·s.

### Composition (M12)

| | | |
|---|---|---|
| 4-HH-V | (1-1) | 15% |
| 3-HH-V1 | (1-1) | 6% |
| 1-HH-2V1 | (1-1) | 6% |
| 3-HH-2V1 | (1-1) | 4% |
| V2-BB-1 | (1-3) | 5% |
| 1V2-BB-1 | (1-3) | 5% |
| 3-HHB-1 | (1-5) | 3% |
| 3-HB(F)BH-3 | (M2) | 4% |
| 3-H2B(2F,3F)-O2 | (3-2) | 7% |
| 3-HHB(2F,3F)-O2 | (3-8) | 8% |
| 3-HH1OB(2F,3F)-O2 | (3-10) | 8% |
| 2-HchB(2F,3F)-O2 | (3-12) | 8% |
| 3-HDhB(2F,3F)-O2 | (3-13) | 3% |
| 5-HDhB(2F,3F)-O2 | (3-13) | 4% |
| 2-BB(2F,3F)B-3 | (3-19) | 7% |
| 2-BB(2F,3F)B-4 | (3-19) | 7% |

NI=88.2° C.; Tc<−20° C.; Δn=0.115; Δϵ=−2.1; η=18.3 mPa·s.

### Composition (M13)

| | | |
|---|---|---|
| 2-HH-3 | (1-1) | 12% |
| 1-BB-5 | (1-3) | 12% |
| 3-HHB-1 | (1-5) | 4% |
| 3-HHB-O1 | (1-5) | 3% |
| 3-HBB-2 | (1-6) | 3% |
| V2-H2B(2F,3F)-O2 | (3-2) | 8% |
| V2-H1OB(2F,3F)-O4 | (3-3) | 4% |
| 3-BB(2F,3F)-O2 | (3-6) | 7% |
| 2-HHB(2F,3F)-O2 | (3-8) | 7% |
| 3-HHB(2F,3F)-O2 | (3-8) | 7% |
| 3-HH2B(2F,3F)-O2 | (3-9) | 7% |
| 5-HH2B(2F,3F)-O2 | (3-9) | 4% |
| V-HH2B(2F,3F)-O2 | (3-9) | 6% |
| V2-HBB(2F,3F)-O2 | (3-14) | 5% |
| V-HBB(2F,3F)-O2 | (3-14) | 5% |
| V-HBB(2F,3F)-O4 | (3-14) | 6% |

NI=89.9° C.; Tc<−20° C.; Δn=0.122; Δϵ=−4.2; η=23.4 mPa·s.

### Composition (M14)

| | | |
|---|---|---|
| 3-HH-V | (1-1) | 27% |
| 3-HH-V1 | (1-1) | 6% |
| V-HHB-1 | (1-5) | 3% |
| 3-HB(2F,3F)-O2 | (3-1) | 3% |
| V-HB(2F,3F)-O2 | (3-1) | 3% |
| V2-HB(2F,3F)-O2 | (3-1) | 5% |
| 5-H2B(2F,3F)-O2 | (3-2) | 5% |
| V2-BB(2F,3F)-O2 | (3-6) | 3% |
| 1V2-BB(2F,3F)-O2 | (3-6) | 3% |
| 3-HHB(2F,3F)-O2 | (3-8) | 6% |
| V-HHB(2F,3F)-O2 | (3-8) | 6% |
| V-HHB(2F,3F)-O4 | (3-8) | 5% |
| V2-HHB(2F,3F)-O2 | (3-8) | 4% |
| V-HHB(2F,3Cl)-O2 | (3-11) | 3% |
| V2-HBB(2F,3F)-O2 | (3-14) | 5% |
| V-HBB(2F,3F)-O2 | (3-14) | 4% |
| V-HBB(2F,3F)-O4 | (3-14) | 5% |
| V2-BB(2F,3F)B-1 | (3-19) | 4% |

NI=77.1° C.; Tc<−20° C.; Δn=0.101; Δϵ=−3.0; η=13.9 mPa·s.

### Composition (M15)

| | | |
|---|---|---|
| 2-HH-3 | (1-1) | 12% |
| 1-BB-3 | (1-3) | 6% |
| 3-HHB-1 | (1-5) | 3% |
| 3-HHB-O1 | (1-5) | 4% |
| 3-HBB-2 | (1-6) | 6% |
| 3-B(F)BB-2 | (1-7) | 3% |
| 3-HB(2F,3F)-O4 | (3-1) | 6% |
| 3-H2B(2F,3F)-O2 | (3-2) | 8% |
| 3-H1OB(2F,3F)-O2 | (3-3) | 4% |
| 3-BB(2F,3F)-O2 | (3-6) | 7% |
| 2-HHB(2F,3F)-O2 | (3-8) | 6% |
| 3-HHB(2F,3F)-O2 | (3-8) | 10% |
| 5-HHB(2F,3F)-O2 | (3-8) | 8% |
| 2-HBB(2F,3F)-O2 | (3-14) | 5% |
| 3-HBB(2F,3F)-O2 | (3-14) | 7% |
| 5-HBB(2F,3F)-O2 | (3-14) | 5% |

NI=93.0° C.; Tc<−20° C.; Δn=0.124; Δϵ=−4.5; η=25.0 mPa·s.

### Composition (M16)

| | | |
|---|---|---|
| 3-HH-V | (1-1) | 15% |
| 3-HH-V1 | (1-1) | 6% |
| 2-HH-3 | (1-1) | 9% |
| 3-HH-5 | (1-1) | 3% |
| 1V2-HH-3 | (1-1) | 3% |
| V-HB(2F,3F)-O2 | (3-1) | 7% |
| V2-BB(2F,3F)-O2 | (3-6) | 10% |
| V-HHB(2F,3F)-O1 | (3-8) | 7% |
| V-HHB(2F,3F)-O2 | (3-8) | 9% |
| V2-HHB(2F,3F)-O2 | (3-8) | 8% |
| 3-HH2B(2F,3F)-O2 | (3-9) | 9% |
| V-HBB(2F,3F)-O2 | (3-14) | 8% |
| V-HBB(2F,3F)-O4 | (3-14) | 6% |

NI=87.5° C.; Tc<−20° C.; Δn=0.100; Δϵ=−3.4; η=18.9 mPa·s.

### Composition (M17)

| | | |
|---|---|---|
| 3-HH-V | (1-1) | 33% |
| V-HHB-1 | (1-5) | 3% |
| 3-HB(2F,3F)-O2 | (3-1) | 7% |
| 5-HB(2F,3F)-O2 | (3-1) | 7% |
| 3-BB(2F,3F)-O2 | (3-6) | 8% |
| 3-HHB(2F,3F)-O2 | (3-8) | 4% |
| 5-HHB(2F,3F)-O2 | (3-8) | 5% |
| 3-HH1OB(2F,3F)-O2 | (3-10) | 5% |
| 2-HBB(2F,3F)-O2 | (3-14) | 3% |
| 3-HBB(2F,3F)-O2 | (3-14) | 8% |
| 4-HBB(2F,3F)-O2 | (3-14) | 5% |
| 5-HBB(2F,3F)-O2 | (3-14) | 8% |
| 2-BB(2F,3F)B-3 | (3-19) | 4% |

NI=76.4° C.; Tc<−20° C.; Δn=0.104; Δϵ=−3.2; η=15.6 mPa·s.

### Composition (M18)

| | | |
|---|---|---|
| 2-HH-3 | (1-1) | 5% |
| 3-HH-VFF | (1-1) | 30% |
| 1-BB-3 | (1-3) | 5% |
| 3-HHB-1 | (1-5) | 3% |
| 3-HBB-2 | (1-6) | 3% |
| 2-H1OB(2F,3F)-O2 | (3-3) | 6% |
| 3-H1OB(2F,3F)-O2 | (3-3) | 4% |
| 3-BB(2F,3F)-O2 | (3-6) | 3% |
| 2-HH1OB(2F,3F)-O2 | (3-10) | 14% |
| 2-HBB(2F,3F)-O2 | (3-14) | 7% |
| 3-HBB(2F,3F)-O2 | (3-14) | 11% |
| 5-HBB(2F,3F)-O2 | (3-14) | 9% |

NI=78.3° C.; Tc<−20° C.; Δn=0.103; Δϵ=−3.2; η=17.7 mPa·s.

### Composition (M19)

| | | |
|---|---|---|
| 3-HH-4 | (1-1) | 14% |
| V-HHB-1 | (1-5) | 10% |
| 3-HBB-2 | (1-6) | 7% |
| V-HB(2F,3F)-O2 | (3-1) | 10% |
| V2-HB(2F,3F)-O2 | (3-1) | 10% |
| 2-H1OB(2F,3F)-O2 | (3-3) | 3% |
| 3-H1OB(2F,3F)-O2 | (3-3) | 3% |
| 2O-BB(2F,3F)-O2 | (3-6) | 3% |
| V2-BB(2F,3F)-O2 | (3-6) | 8% |
| V2-HHB(2F,3F)-O2 | (3-8) | 5% |
| V-HHB(2F,3C1)-O2 | (3-11) | 7% |
| 2-HBB(2F,3F)-O2 | (3-14) | 3% |
| 3-HBB(2F,3F)-O2 | (3-14) | 3% |
| V-HBB(2F,3F)-O2 | (3-14) | 6% |
| V-HBB(2F,3F)-O4 | (3-14) | 8% |

NI=75.9° C.; Tc<−20° C.; Δn=0.114; Δϵ=−3.9; η=24.7 mPa·s.

### Composition (M20)

| | | |
|---|---|---|
| 3-HH-V | (1-1) | 33% |
| 3-HH-V1 | (1-1) | 5% |
| 3-HB-O2 | (1-2) | 3% |
| 1-BB-3 | (1-3) | 3% |
| 3-HHB-1 | (1-5) | 6% |
| 2-BB(F)B-3 | (1-8) | 2% |
| 3-HB(2F,3F)-O2 | (3-1) | 3% |
| 2O-B(2F)B(2F,3F)-O2 | (3-7) | 5% |
| 2O-B(2F)B(2F,3F)-O4 | (3-7) | 12% |
| 2-HHB(2F,3F)-O2 | (3-8) | 4% |
| 3-HHB(2F,3F)-O2 | (3-8) | 8% |
| 5-HBB(2F,3F)-O2 | (3-14) | 4% |
| 3-dhBB(2F,3F)-O2 | (3-16) | 8% |
| 3-HB(2F,3F)B-2 | (3-17) | 4% |

NI=72.6° C.; Tc<−20° C.; Δn=0.105; Δϵ=−2.5; η=15.7 mPa·s.

### Composition (M21)

| | | |
|---|---|---|
| 2-HH-3 | (1-1) | 12% |
| 1-BB-5 | (1-3) | 12% |
| 3-HHB-1 | (1-5) | 4% |
| 3-HHB-O1 | (1-5) | 3% |
| 3-HBB-2 | (1-6) | 3% |
| 3-HB(2F,3F)-O4 | (3-1) | 6% |
| 3-H2B(2F,3F)-O2 | (3-2) | 8% |
| 3-H1OB(2F,3F)-02 | (3-3) | 4% |
| 3-BB(2F,3F)-O2 | (3-6) | 7% |
| 2-HHB(2F,3F)-O2 | (3-8) | 7% |
| 3-HHB(2F,3F)-O2 | (3-8) | 7% |
| 3-HH2B(2F,3F)-O2 | (3-9) | 7% |
| 5-HH2B(2F,3F)-O2 | (3-9) | 4% |
| 2-HBB(2F,3F)-O2 | (3-14) | 5% |
| 3-HBB(2F,3F)-O2 | (3-14) | 5% |
| 4-HBB(2F,3F)-O2 | (3-14) | 6% |

NI=82.8° C.; Tc<−20° C.; Δn=0.118; Δϵ=−4.4; η=22.5 mPa·s.

### Composition (M22)

| | | |
|---|---|---|
| 3-HH-V | (1-1) | 27% |
| 3-HH-V1 | (1-1) | 6% |
| V-HHB-1 | (1-5) | 3% |
| 3-HB(2F,3F)-O2 | (3-1) | 7% |
| 5-HB(2F,3F)-O2 | (3-1) | 7% |
| 3-BB(2F,3F)-O2 | (3-6) | 8% |
| 3-HHB(2F,3F)-O2 | (3-8) | 5% |
| 5-HHB(2F,3F)-O2 | (3-8) | 4% |
| 3-HH1OB(2F,3F)-O2 | (3-10) | 4% |
| 2-HBB(2F,3F)-O2 | (3-14) | 3% |
| 3-HBB(2F,3F)-O2 | (3-14) | 8% |
| 4-HBB(2F,3F)-O2 | (3-14) | 5% |
| 5-HBB(2F,3F)-O2 | (3-14) | 8% |
| 2-BB(2F,3F)B-3 | (3-19) | 5% |

NI=78.1° C.; Tc<−20° C.; Δn=0.107; Δϵ=−3.2; η=15.9 mPa·s.

### Composition (M23)

| | | |
|---|---|---|
| 3-HH-4 | (1-1) | 14% |
| V-HHB-1 | (1-5) | 10% |
| 3-HBB-2 | (1-6) | 7% |
| 3-HB(2F,3F)-O2 | (3-1) | 10% |
| 5-HB(2F,3F)-O2 | (3-1) | 10% |
| 3-H2B(2F,3F)-O2 | (3-2) | 8% |
| 5-H2B(2F,3F)-O2 | (3-2) | 8% |
| 3-HDhB(2F,3F)-O2 | (3-13) | 5% |
| 2-HBB(2F,3F)-O2 | (3-14) | 6% |
| 3-HBB(2F,3F)-O2 | (3-14) | 8% |
| 4-HBB(2F,3F)-O2 | (3-14) | 7% |
| 5-HBB(2F,3F)-O2 | (3-14) | 7% |

NI=88.5° C.; Tc<−20° C.; Δn=0.108; Δϵ=−3.8; η=24.6 mPa·s.

### Composition (M24)

| | | |
|---|---|---|
| 3-HH-V | (1-1) | 42% |
| 3-HH-V1 | (1-1) | 5% |
| 1-BB-3 | (1-3) | 3% |
| V-HHB-1 | (1-5) | 2% |
| 2O-B(2F)B(2F,3F)-O2 | (3-7) | 6% |
| 2O-B(2F)B(2F,3F)-O4 | (3-7) | 13% |
| 2-HHB(2F,3F)-O2 | (3-8) | 4% |
| 3-HHB(2F,3F)-O2 | (3-8) | 4% |
| 3-HHB(2F,3F)-1 | (3-8) | 4% |
| 3-dhBB(2F,3F)-O2 | (3-16) | 5% |
| 3-HB(2F)B(2F,3F)-O2 | (3-18) | 7% |
| V-H2BBB(2F,3F)-O2 | (3-25) | 5% |

NI=71.8° C.; Tc<−20° C.; Δn=0.103; Δϵ=−2.5; η=14.2 mPa·s.

### Composition (M25)

| | | |
|---|---|---|
| 5-HH-V | (1-1) | 18% |
| 7-HB-1 | (1-2) | 5% |
| V-HHB-1 | (1-5) | 7% |
| V2-HHB-1 | (1-5) | 7% |
| 3-HBB(F)B-3 | (1-13) | 8% |
| 3-HB(2F,3F)-O4 | (3-1) | 15% |
| 3-chB(2F,3F)-O2 | (3-5) | 7% |
| 2-HchB(2F,3F)-O2 | (3-12) | 8% |
| 3-HBB(2F,3F)-O2 | (3-14) | 8% |
| 4-HBB(2F,3F)-O2 | (3-14) | 5% |
| 5-HBB(2F,3F)-O2 | (3-14) | 7% |
| 3-dhBB(2F,3F)-O2 | (3-16) | 5% |

NI=98.8° C.; Tc<−20° C.; Δn=0.111; Δϵ=−3.2; η=23.9 mPa·s.

### Composition (M26)

| | | |
|---|---|---|
| 3-HH-V | (1-1) | 11% |
| 3-HH-VFF | (1-1) | 7% |
| F3-HH-V | (—) | 10% |
| 3-HHEH-3 | (1-4) | 4% |
| 3-HB(F)HH-2 | (1-10) | 4% |
| 3-HHEBH-3 | (1-11) | 4% |
| 3-H2B(2F,3F)-O2 | (3-2) | 18% |
| 5-H2B(2F,3F)-O2 | (3-2) | 17% |
| 3-HHB(2F,3Cl)-O2 | (3-11) | 5% |
| 3-HDhB(2F,3F)-O2 | (3-13) | 5% |
| 3-HBB(2F,3Cl)-O2 | (3-15) | 8% |
| 5-HBB(2F,3Cl)-O2 | (3-15) | 7% |

NI=77.5° C.; Tc<−20° C.; Δn=0.084; Δϵ=−2.6; η=22.8 mPa·s.

### Composition (M27)

| | | |
|---|---|---|
| 3-HH-V | (1-1) | 11% |
| 1-BB-5 | (1-3) | 5% |
| 3-HB(2F,3F)-O2 | (3-1) | 8% |
| 3-H2B(2F,3F)-O2 | (3-2) | 10% |
| 3-BB(2F,3F)-O2 | (3-6) | 10% |
| 2O-BB(2F,3F)-O2 | (3-6) | 3% |
| 2-HHB(2F,3F)-O2 | (3-8) | 4% |
| 3-HHB(2F,3F)-O2 | (3-8) | 7% |
| 2-HHB(2F,3F)-1 | (3-8) | 5% |
| 3-HDhB(2F,3F)-O2 | (3-13) | 6% |
| 2-HBB(2F,3F)-O2 | (3-14) | 4% |
| 3-HBB(2F,3F)-O2 | (3-14) | 7% |
| 3-dhBB(2F,3F)-O2 | (3-16) | 4% |
| 2-BB(2F,3F)B-3 | (3-19) | 6% |
| 2-BB(2F,3F)B-4 | (3-19) | 6% |
| 3-HH1OCro(7F,8F)-5 | (3-27) | 4% |

NI=70.6° C.; Tc<−20° C.; Δn=0.129; Δϵ=−4.3; η=27.0 mPa·s.

### Composition (M28)

| | | |
|---|---|---|
| V-HH-V | (1-1) | 24% |
| V-HH-V1 | (1-1) | 20% |
| 3-HB(2F,3F)-O2 | (3-1) | 5% |
| V2-BB(2F,3F)-O2 | (3-6) | 8% |
| 3-HHB(2F,3F)-O2 | (3-8) | 6% |
| V-HHB(2F,3F)-O2 | (3-8) | 7% |
| V-HHB(2F,3F)-O4 | (3-8) | 4% |
| 2-HBB(2F,3F)-O2 | (3-14) | 2% |
| 3-HBB(2F,3F)-O2 | (3-14) | 6% |
| V-HBB(2F,3F)-O2 | (3-14) | 7% |
| V-HBB(2F,3F)-O4 | (3-14) | 6% |
| 2-BB(2F,3F)B-3 | (3-19) | 5% |

NI=73.5° C.; Tc<−20° C.; Δn=0.106; Δϵ=−2.7; η=17.0 mPa·s.

### Composition (M29)

| | | |
|---|---|---|
| 2-HH-3 | (1-1) | 19% |
| 3-HHB-l | (1-5) | 3% |
| V-HHB-1 | (1-5) | 10% |
| V2-HHB-1 | (1-5) | 10% |
| 3-DhB(2F,3F)-O2 | (3-4) | 5% |
| 2-BB(2F,3F)-O2 | (3-6) | 9% |
| 3-BB(2F,3F)-O2 | (3-6) | 9% |
| 3-HH2B(2F,3F)-O2 | (3-9) | 6% |
| 3-HDhB(2F,3F)-O2 | (3-13) | 14% |
| 2-HBB(2F,3F)-O2 | (3-14) | 2% |
| 3-HBB(2F,3F)-O2 | (3-14) | 6% |
| V-HBB(2F,3F)-O2 | (3-14) | 7% |

NI=86.0° C.; Tc<−20° C.; Δn=0.110; Δϵ=−3.8; η=22.9 mPa·s.

### Composition (M30)

| | | |
|---|---|---|
| 3-HH-V | (1-1) | 40% |
| 3-HH-V1 | (1-1) | 5% |
| 3-HHB-O1 | (1-5) | 3% |
| 1-BB(F)B-2V | (1-8) | 3% |
| 3-GHB(F,F)-F | (2-7) | 3% |
| 3-BB(F,F)XB(F,F)-F | (2-18) | 11% |
| 3-HHBB(F,F)-F | (2-19) | 4% |
| 3-HBBXB(F,F)-F | (2-23) | 8% |
| 3-BB(F)B(F,F)XB(F,F)-F | (2-29) | 3% |
| 4-BB(F)B(F,F)XB(F,F)-F | (2-29) | 6% |
| 5-BB(F)B(F,F)XB(F,F)-F | (2-29) | 6% |
| 3-HDhB(2F,3F)-O2 | (3-13) | 4% |
| 2-dhBB(2F,3F)-O2 | (3-16) | 4% |

NI=85.2° C.; Tc<−20° C.; Δn=0.114; Δϵ=7.3; η=15.0 mPa·s.

### Composition (M31)

| | | |
|---|---|---|
| 3-HH-V1 | (1-1) | 5% |
| V-HHB-1 | (1-5) | 4% |
| 1-BB(F)B-2V | (1-8) | 3% |
| 2-BB(F)B-2V | (1-8) | 3% |
| 3-GB(F,F)XB(F,F)-F | (2-14) | 3% |
| 3-BB(F)B(F,F)-F | (2-15) | 9% |
| 3-BB(F)B(F,F)-CF3 | (2-16) | 4% |
| 3-HBBXB(F,F)-F | (2-23) | 5% |
| 4-GB(F)B(F,F)XB(F,F)-F | (2-27) | 3% |
| 3-BB(F)B(F,F)XB(F,F)-F | (2-29) | 3% |
| 4-BB(F)B(F,F)XB(F,F)-F | (2-29) | 6% |
| 3-HHB(2F,3F)-O2 | (3-8) | 6% |
| 3-HBB(2F,3F)-O2 | (3-14) | 3% |
| V-HBB(2F,3F)-O2 | (3-14) | 4% |

NI=83.2° C.; Tc<−20° C.; Δn=0.120; Δϵ=6.2; η=13.6 mPa·s.

### Composition (M32)

| | | |
|---|---|---|
| 3-HB-O2 | (1-2) | 10% |
| 3-HHB-1 | (1-5) | 8% |
| 3-HHB-3 | (1-5) | 8% |
| 3-HHB-01 | (1-5) | 4% |
| 3-HB-C | (—) | 10% |
| 3-HB(F)-C | (—) | 15% |
| 3-HHB-F | (2) | 4% |
| 2-HHB(F)-F | (2) | 11% |
| 3-HHB(F)-F | (2) | 11% |
| 5-HHB(F)-F | (2) | 10% |
| 3-HHB(F)-C | (—) | 8% |
| 3-BB(F,F)XB(F,F)-F | (2-18) | 1% |

NI=95.5° C.; Tc<−20° C.; η=22.3 mPa·s; Δn=0.100; Δϵ=8.1; Vth=1.50 V.

### Composition (M33)

| | | |
|---|---|---|
| 3-HH-V | (1-1) | 13% |
| 3-BB(F)B(F,F)XB(F,F)-F | (2-29) | 2% |
| 4-BB(F)B(F,F)XB(F,F)-F | (2-29) | 10% |
| 5-BB(F)B(F,F)XB(F,F)-F | (2-29) | 6% |
| 3-BB(F,F)XB(F)B(F,F)-F | (2-30) | 6% |
| 4-BTB(F)B(F,F)XB(F,F)-F | (—) | 6% |
| 5-BTB(F)B(F,F)XB(F,F)-F | (—) | 6% |
| 3-HB(F)TB-2 | (—) | 5% |
| 3-HB(F)TB-3 | (—) | 4% |
| 3-BB(F)TB-2 | (—) | 7% |
| 3-BB(F)TB-3 | (—) | 7% |
| 3-BB(F)TB-4 | (—) | 7% |
| 2-BTB-O1 | (—) | 7% |
| 3-BTB-O1 | (—) | 7% |
| 4-BTB-O1 | (—) | 7% |

NI=113.4° C.; Tc<−20° C.; η=94.0 mPa·s; Δn=0.300; Δϵ=11.1; Vth=1.50 V.

### Example 1

### (1) Transmittance of a TN Device

TN devices having composition (M1) to composition (M33) were produced. The relation between an applied voltage and transmittance was observed by the method described below. In any cases, the device was bright at 0 V, and was dark at 150 V, and the transmittance of the device decreased with an decrease in the applied voltage. This shows that the optical anisotropy of the composition depends on the voltage. We thus conclude that the device is suitable for a light switching device, since polarized light can be controlled by the device. (2) Voltage-transmittance curve (measured at 25° C.): An LCD evaluation system Model LCD-5100 made by Otsuka Electronics Co., Ltd. was used for measurement. The light source was a halogen lamp. A sample was placed in a TN device with a normally white mode, in which the distance (cell gap) between the two glass substrates having an electrode was 15 micrometers, and the twist angle was 80 degrees. The device was placed in the luminance meter in order that an incident angle was 45 degrees to the substrate. The voltage to be applied to this device (32 Hz, rectangular waves) was stepwise increased in 5 V increments from 0 V up to 150 V. During the increase, the device was irradiated with light, and the amount of light passing through the device was measured. A voltage-transmittance curve was prepared, in which the maximum amount of light corresponded to 100% transmittance and the minimum amount of light corresponded to 0% transmittance.

The advantage of the disclosure is use of a liquid crystal composition satisfying at least one of characteristics such as a high maximum temperature of a nematic phase, a low minimum temperature of a nematic phase, a wide temperature range of a liquid crystal phase, a small viscosity, a large optical anisotropy, a large positive or large negative dielectric anisotropy, a large specific resistance, a high stability to light, a high stability to heat and a large elastic constant. Another advantage is use of a liquid crystal composition having a suitable balance between at least two of these characteristics. Another advantage is use of a light switching device having such a composition. Another advantage is use of a light switching device having characteristics such as a short response time, a large voltage holding ratio, a low threshold voltage, a large contrast and a long service life.

The light switching device having the liquid crystal composition described above is used for the LIDAR technology or other technologies.

What is claimed is:

1. Use of a liquid crystal composition including at least one compound selected from compounds represented by formula (1) as a first component, for a light switching deice where the retardation is changed from 0 to λ/2 by a voltage change: 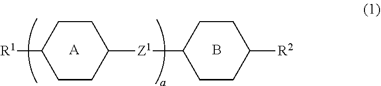
in formula (1), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine; ring A and ring B are 1,4-cyclohexylene, 1,4-phenylene, 2-fluoro-1,4-phenylene or 2,5-difluoro-1,4-phenylene; Z¹ is a single bond, ethylene, vinylene, methyleneoxy or carbonyloxy; and a is 1, 2 or 3.

2. Use for the light switching device according to claim 1, of a liquid crystal composition including at least one compound selected from compounds represented by formula (1-1) to formula (1-13) as a first component: 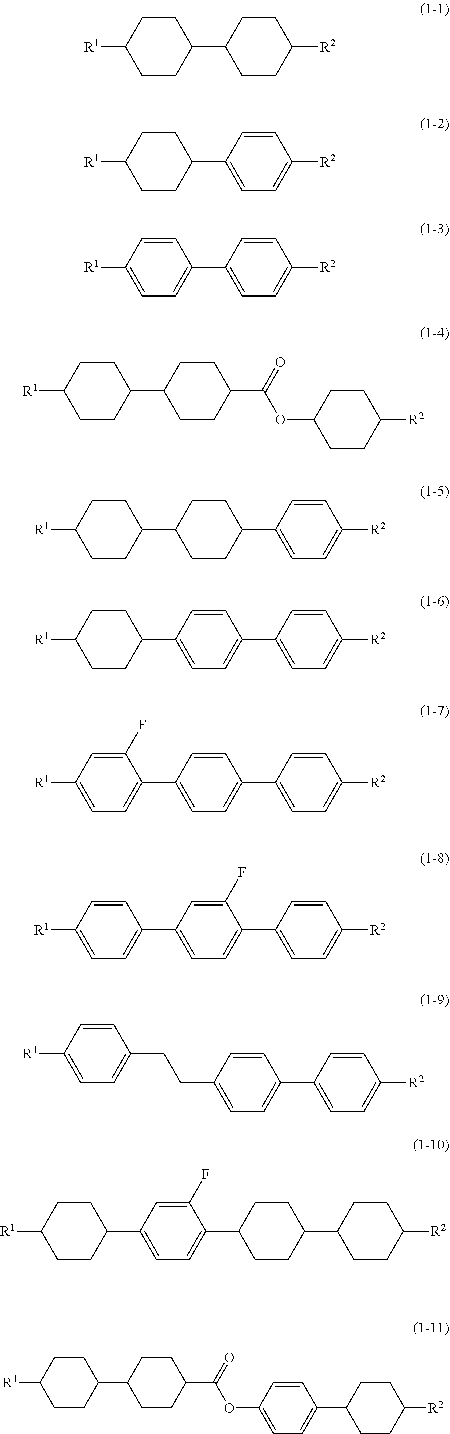 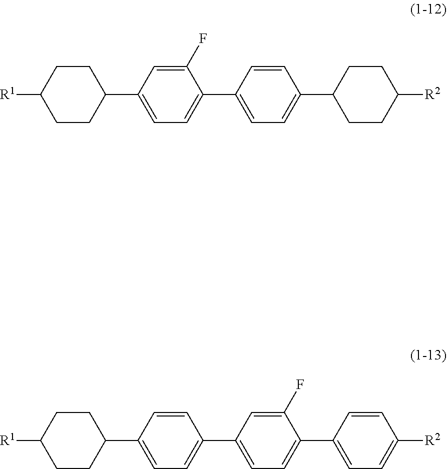
in formula (1-1) to formula (1-13), R¹ and R² are alkyl having 1 to 12 carbons, alkoxy having 1 to 12 carbons, alkenyl having 2 to 12 carbons or alkenyl having 2 to 12 carbons in which at least one hydrogen has been replaced by fluorine or chlorine.

3. Use for the light switching device according to claim 1, of a liquid crystal composition in which the ratio of the first component is in the range of 10% to 90%.

4. Use for the light switching device according to claim 1, of a liquid crystal composition including at least one compound selected from compounds represented by formula (2) as a second component: 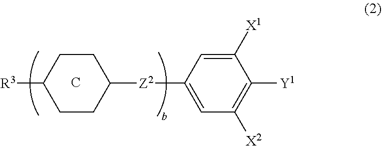
in formula (2), R³ is alkyl having 1 to 12 carbons, alkoxy having 1 to 12 carbons or alkenyl having 2 to 12 carbons; ring C is 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl or tetrahydropyran-2,5-diyl; Z² is a single bond, ethylene, vinylene, methyleneoxy, carbonyloxy or difluoromethyleneoxy; X¹ and X² are hydrogen or fluorine; Y¹ is fluorine, chlorine, alkyl having 1 to 12 carbons in which at least one hydrogen has been replaced by fluorine or chlorine, alkoxy having 1 to 12 carbons in which at least one hydrogen has been replaced by fluorine or chlorine or alkenyloxy having 2 to 12 carbons in which at least one hydrogen has been replaced by fluorine or chlorine; and b is 1, 2, 3 or 4.

5. Use for the light switching device according to claim 1, of a liquid crystal composition including at least one compound selected from compounds represented by formula (2-1) to formula (2-35) as a second component: 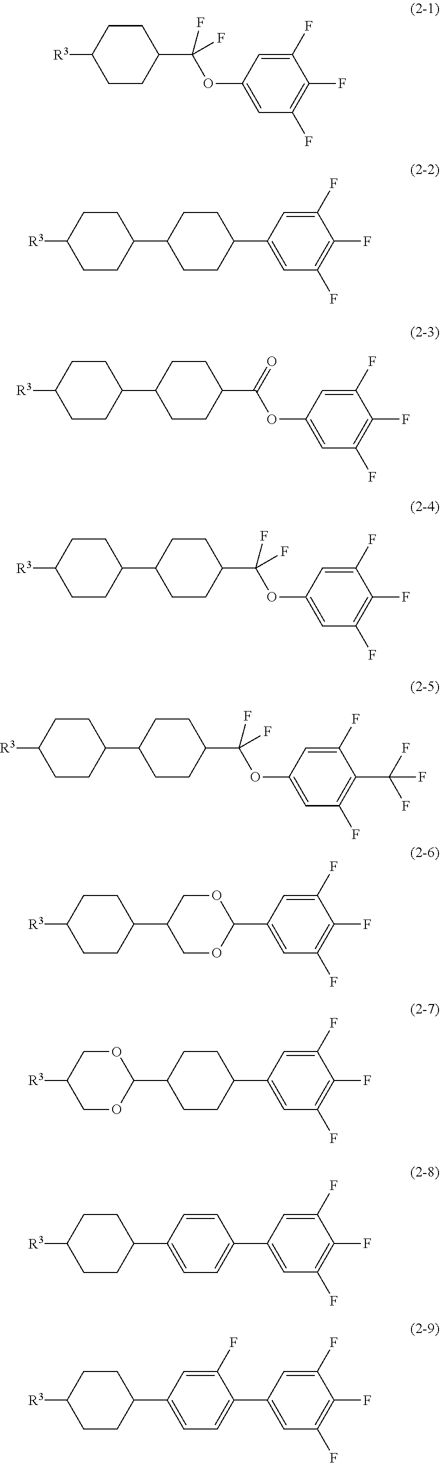 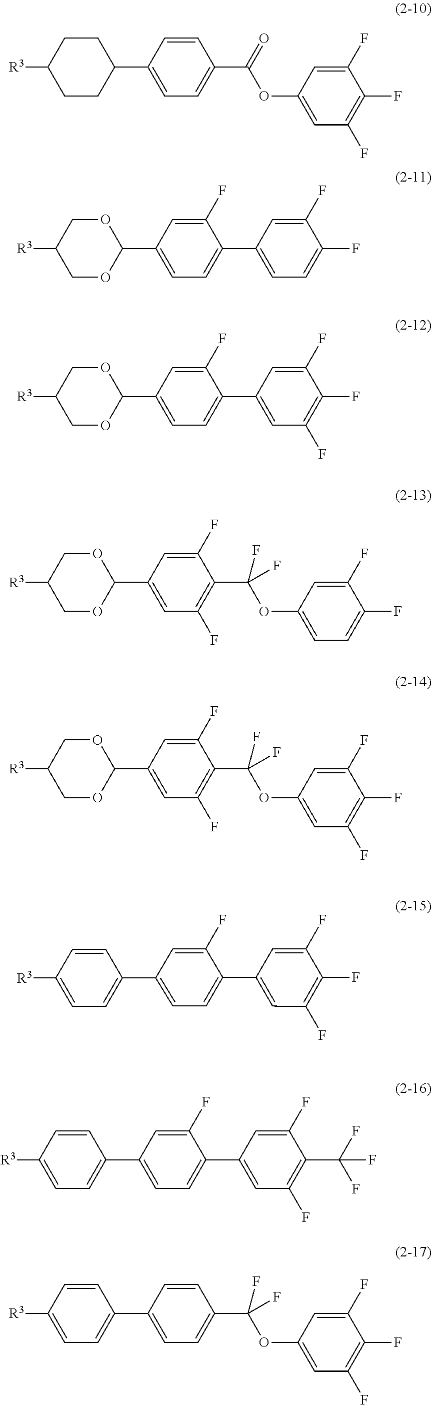 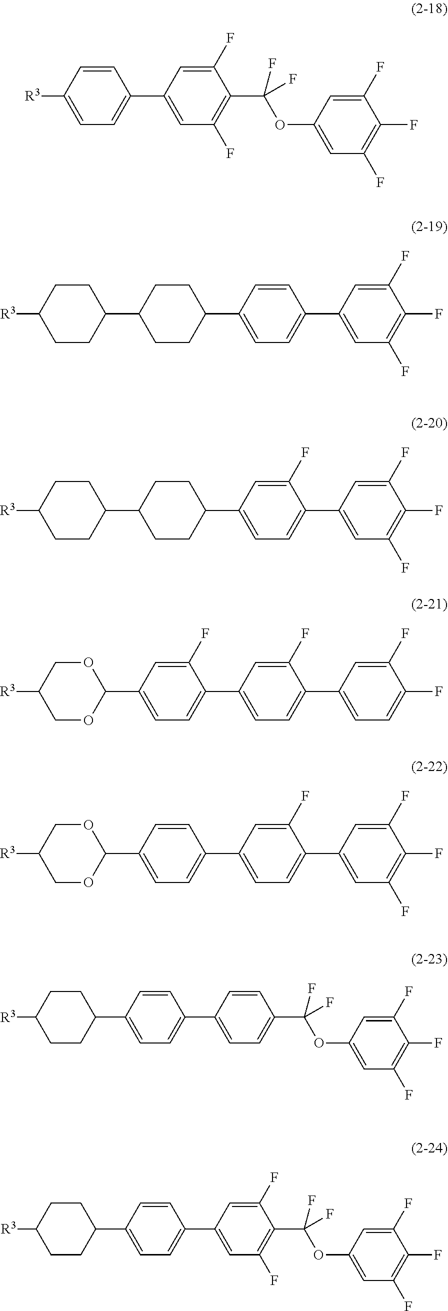 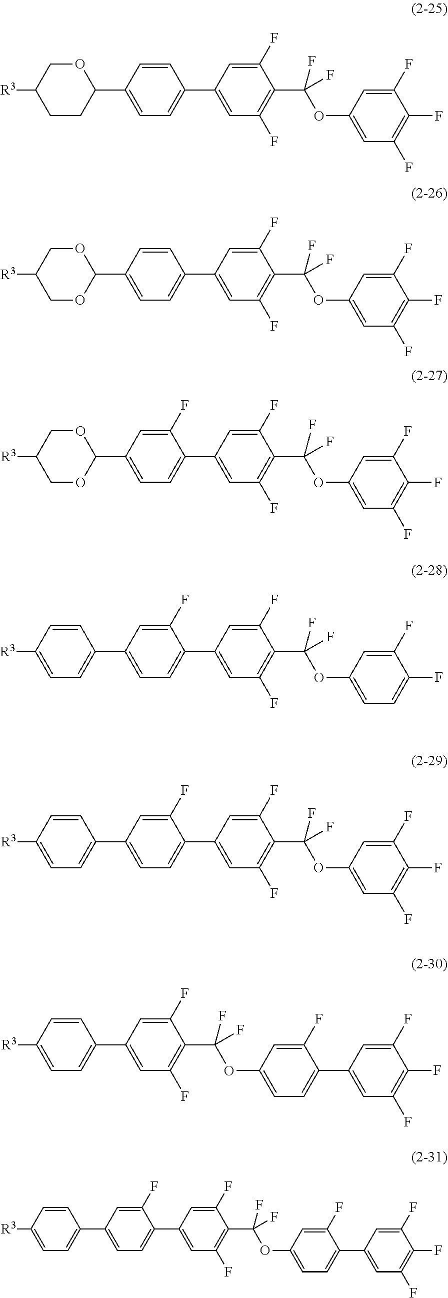 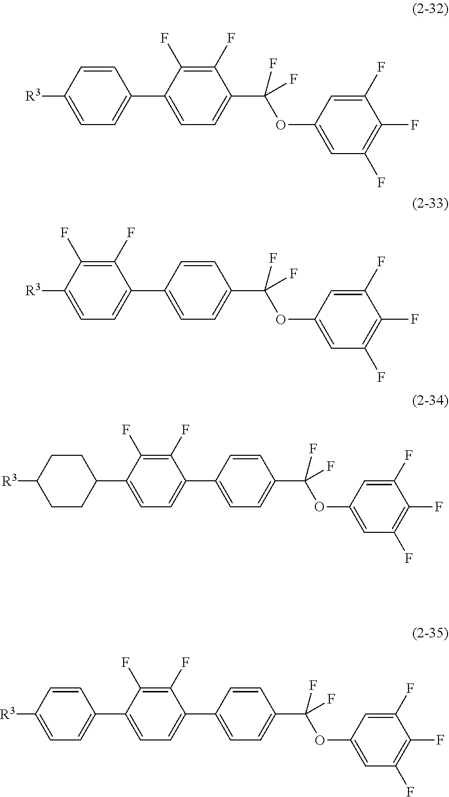
in formula (2-1) to formula (2-35), R³ is alkyl having 1 to 12 carbons, alkoxy having 1 to 12 carbons or alkenyl having 2 to 12 carbons.

6. Use for the light switching device according to claim 4, of a liquid crystal composition in which the ratio of the second component is in the range of 10% to 90%.

7. Use for the light switching device according to claim 1, of a liquid crystal composition including at least one compound selected from compounds represented by formula (3) as a third component: 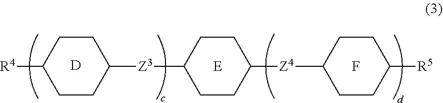
in formula (3), R⁴ and R⁵ are hydrogen, alkyl having 1 to 12 carbons, alkoxy having 1 to 12 carbons, alkenyl having 2 to 12 carbons or alkenyloxy having 2 to 12 carbons; ring D and ring F are 1,4-cyclohexylene, 1,4-cyclohexenylene, tetrahydropyran-2,5-diyl, 1,4-phenylene, 1,4-phenylene in which at least one hydrogen has been replaced by fluorine or chlorine, naphthalene-2,6-diyl, naphthalene-2,6-diyl in which at least one hydrogen has been replaced by fluorine or chlorine, chromane-2,6-diyl or chromane-2,6-diyl in which at least one hydrogen has been replaced by fluorine or chlorine; ring E is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, 7,8-difluorochromane-2,6-diyl, 3,4,5,6-tetrafluorofluorene-2,7-diyl, 4,6-difluorodibenzofuran-3,7-diyl, 4,6-difluorodibenzothiophene-3,7-diyl or 1,1,6,7-tetrafluoroindane-2,5-diyl; Z³ and Z⁴ are a single bond, ethylene, vinylene, methyleneoxy or carbonyloxy; and c is 0, 1, 2 or 3, d is 0 or 1, and the sum of c and d is 3 or less.

8. Use for the light switching device according to claim 1, of a liquid crystal composition including at least one compound selected from compounds represented by formula (3-1) to formula (3-35) as a third component: 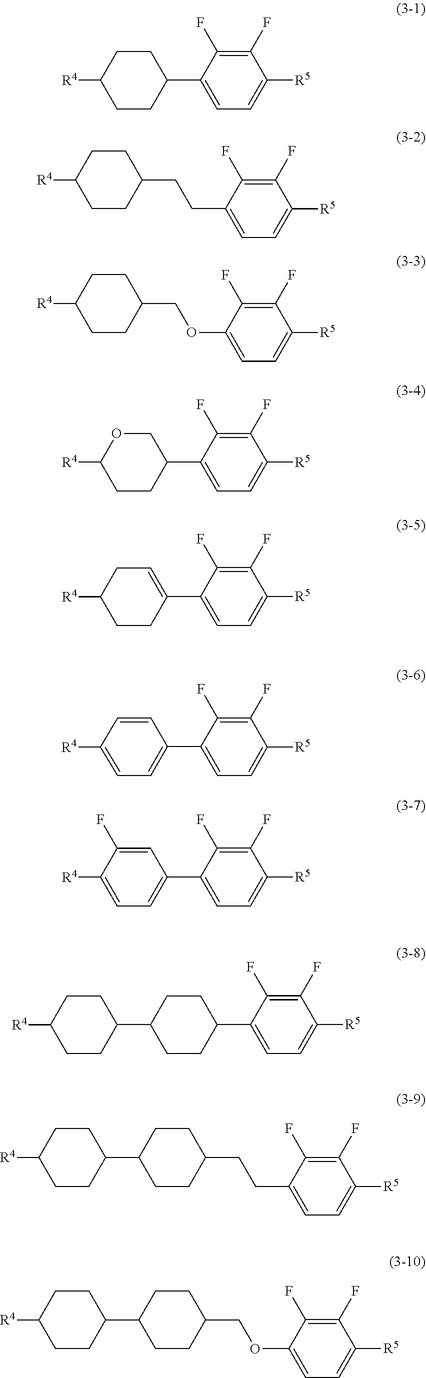 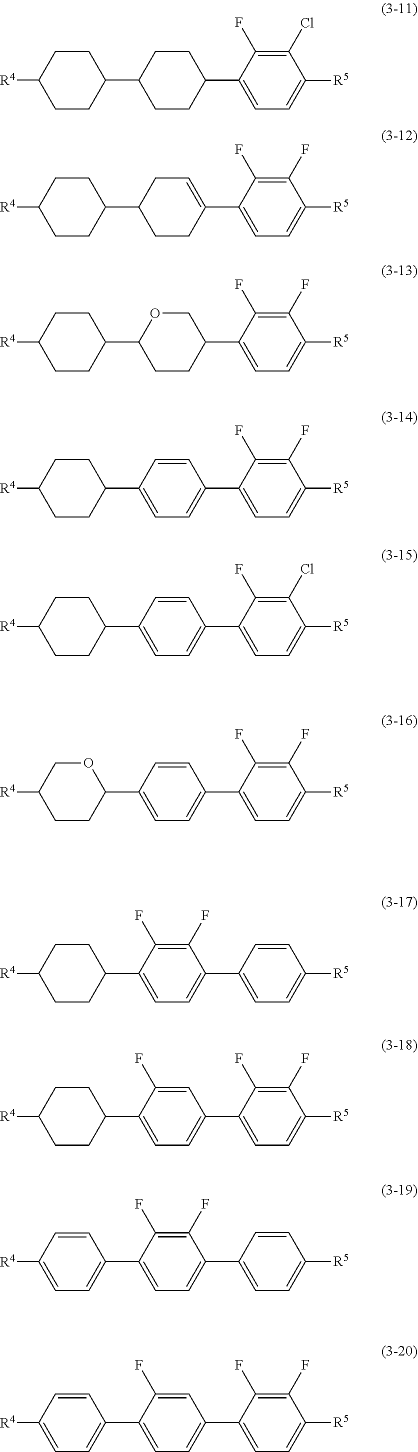 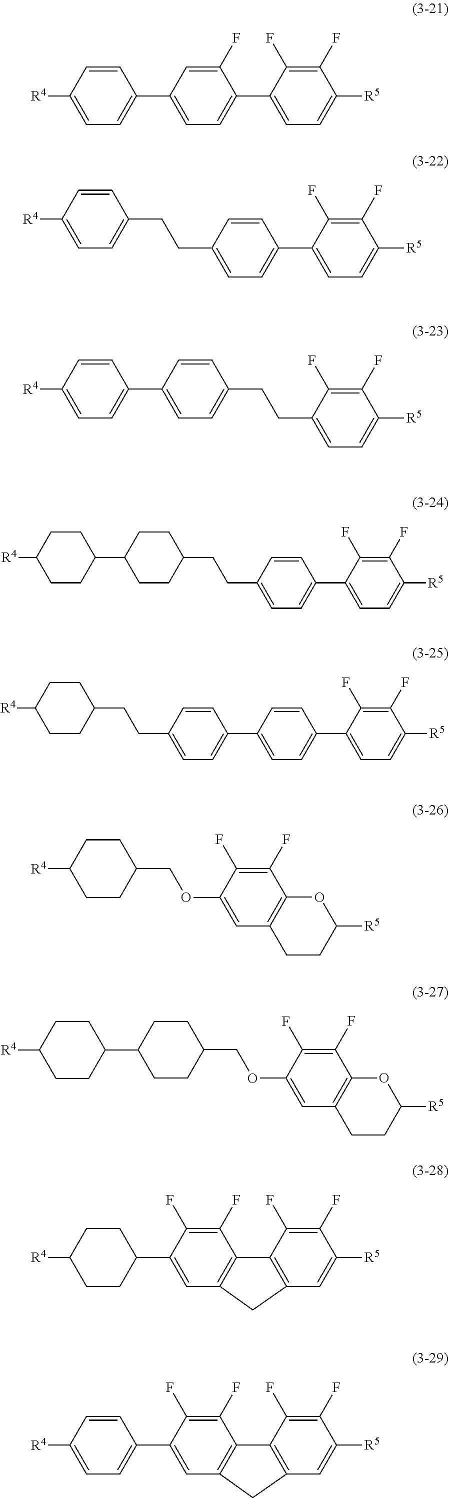 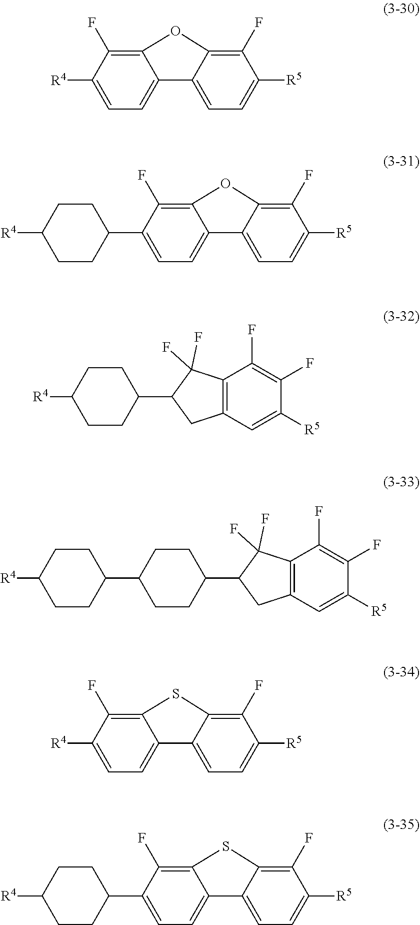
in formula (3-1) to formula (3-35), R⁴ and R⁵ are hydrogen, alkyl having 1 to 12 carbons, alkoxy having 1 to 12 carbons, alkenyl having 2 to 12 carbons or alkenyloxy having 2 to 12 carbons.

9. Use for the light switching device according to claim 7, of a liquid crystal composition in which the ratio of the third component is in the range of 10% to 90%.

10. Use for the light switching device according to claim 1, of a liquid crystal composition including at least one compound selected from polymerizable compounds represented by formula (4) as a first additive: 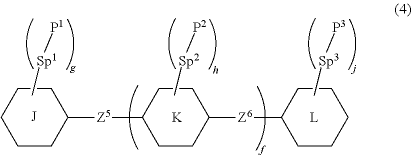
in formula (4), ring J and ring L are cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine; ring K is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons or alkyl having 1 to 12 carbons in which at least one hydrogen has been replaced by fluorine or chlorine; Z⁵ and Z⁶ are a single bond or alkylene having 1 to 10 carbons, and in the alkylene at least one —CH₂— may be replaced by —O—, —CO—, —COO— or —OCO—, at least one —CH₂CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine; P¹, P² and P³ are a polymerizable group; Sp¹, Sp² and Sp³ are a single bond or alkylene having 1 to 10 carbons, and in the alkylene at least one —CH₂— may be replaced by —O—, —COO—, —OCO— or —OCOO—, at least one —CH₂CH₂— may be replaced by —CH═CH— or —C≡C—, and in these groups at least one hydrogen may be replaced by fluorine or chlorine; f is 0, 1 or 2; g, h and j are 0, 1, 2, 3 or 4; and the sum of g, h and j is 1 or more.

11. Use for the light switching device according claim 10, of a liquid crystal composition including at least one compound where in formula (4) P¹, P² and P³ are a group selected from polymerizable groups represented by formula (P-1) to formula (P-5): 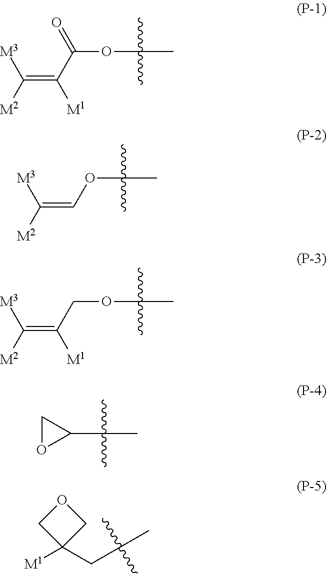
in (P-1) to formula (P-5), M¹ , M² and M³ are hydrogen, fluorine, alkyl having 1 to 5 carbons or alkyl having 1 to 5 carbons in which at least one hydrogen has been replaced by fluorine or chlorine.

12. Use for the light switching device according to claim 1, of a liquid crystal composition including at least one compound selected from polymerizable compounds represented by formula (4-1) to formula (4-29) as a first additive: 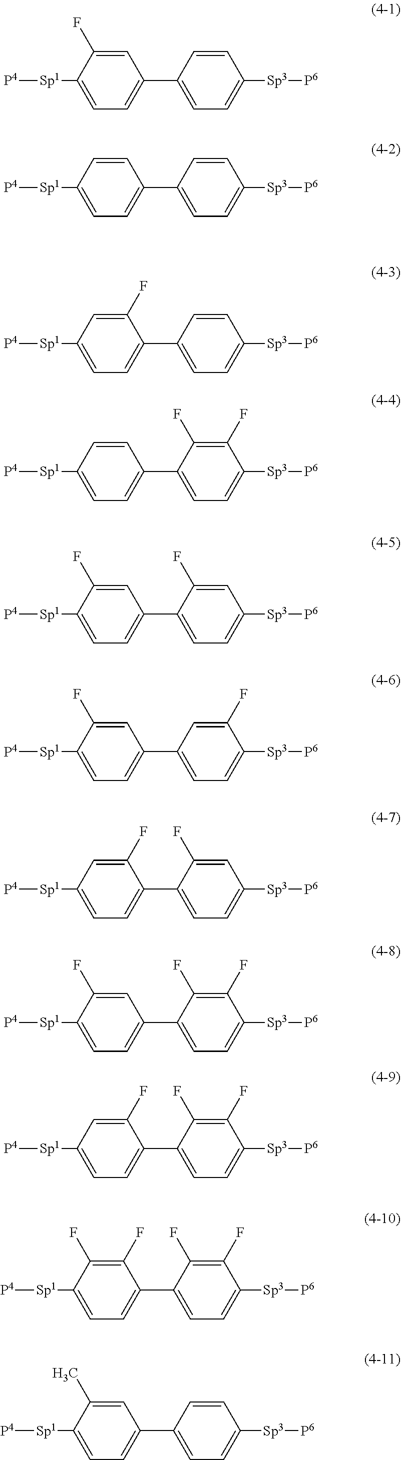 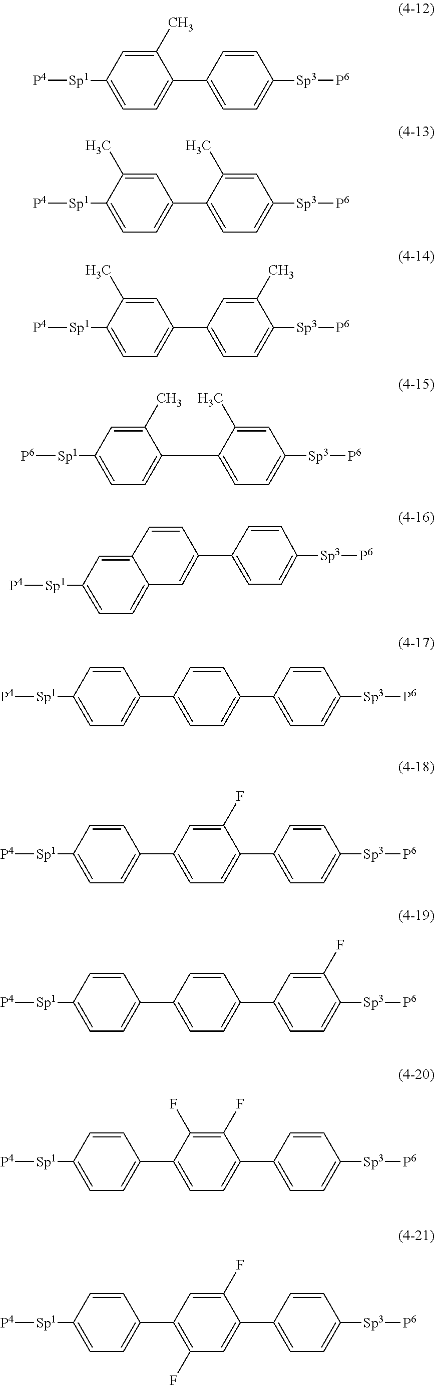 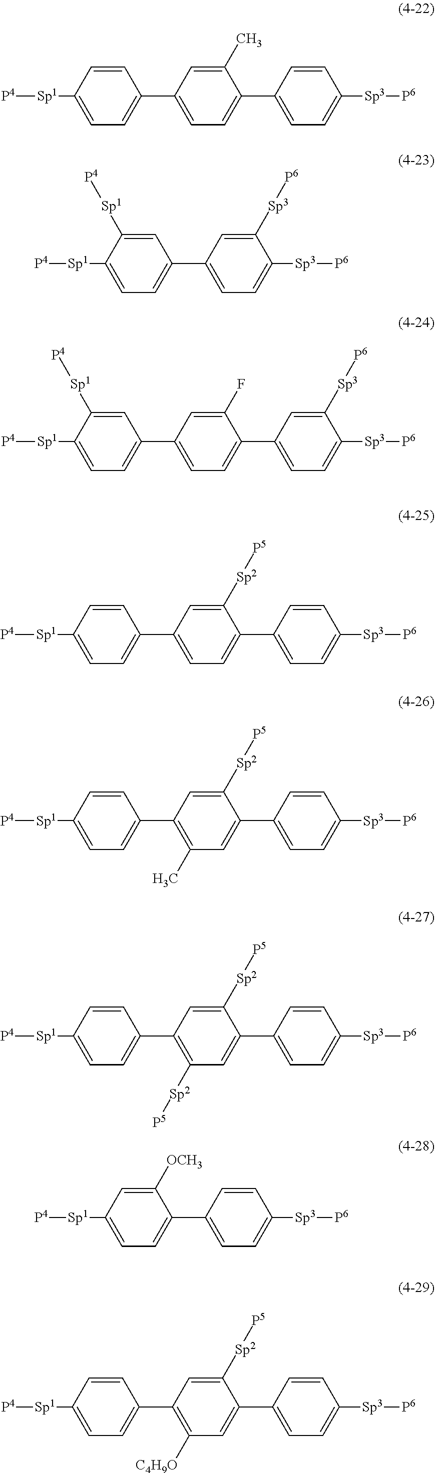
in formula (4-1) to formula (4-29), Sp¹, Sp² and Sp³ are a single bond or alkylene having 1 to 10 carbons, and in the alkylene at least one —CH₂— may be replaced by —O—, —COO—, —OCO— or —OCOO—, at least one —CH₂CH₂— may be replaced by —CH═CH— or —C≡C—, and in these groups at least one hydrogen may be replaced by fluorine or chlorine; and P⁴, P⁵ and P⁶ are a polymerizable group selected from groups of formula (P-1) to formula (P-3): 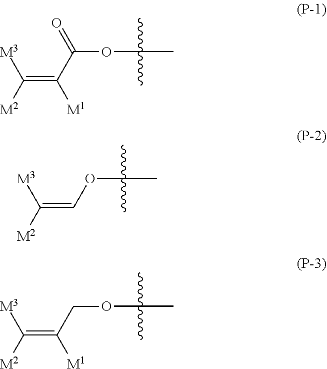
in formula (P-1) to formula (P-3), M¹, M² and M³ are hydrogen, fluorine, alkyl having 1 to 5 carbons or alkyl having 1 to 5 carbons in which at least one hydrogen has been replaced by fluorine or chlorine.

13. Use for the light switching device according to claim 10, of a liquid crystal composition in which the ratio of the first additive is in the range of 0.03% to 10%.

14. Use for the light switching device according to claim 1, of a liquid crystal composition in which the maximum temperature of a nematic phase is 70° C. or higher, the optical anisotropy (measured at 25° C.) at a wavelength of 589 nanometers is 0.07 or more, and the dielectric anisotropy (measured at 25° C.) at a frequency of 1 kHz is 2 or more or −2 or less.

15. A liquid crystal composition described according to claim 1, for a light switching device.

16. A light switching device having two substrates, wherein at least one of the two substrates has a meta-surface, and the two substrates have the liquid crystal composition according to claim 1 between these two.

17. Use of the liquid crystal composition according to claim 1, for a LIDAR technology.
